(19) United States
(12) Patent Application Publication
(10) Pub. No.: US 2026/0146111 A1
(43) Pub. Date: May 28, 2026

(54) HETEROCENES FOR USE IN OLEFIN POLYMERIZATION PROCESSES

(71) Applicant: Chevron Phillips Chemical Company LP, The Woodlands, TX (US)

(72) Inventors: Thilina Gunasekara, Bartlesville, OK (US); Qing Yang, Bartlesville, OK (US); Jared L. Barr, Bartlesville, OK (US); Sierra N. Hinkle, Bartlesville, OK (US)

(21) Appl. No.: 18/960,600

(22) Filed: Nov. 26, 2024

(51) Int. Cl. C08F 110/02; C07F 7/00

(52) U.S. Cl. CPC C08F 110/02; C07F 7/00; C08F 2420/06

(57) ABSTRACT

Disclosed herein are heterocene compounds and catalyst compositions containing the heterocene compounds that can be used for the polymerization of olefins. For example, catalyst compositions disclosed herein can be used in polymerization processes to produce olefin polymers having higher molecular weights than catalyst compositions comprising conventional metallocene compounds. The catalyst compositions comprising the heterocenes also may demonstrate an increased metallocene activity as compared to otherwise identical catalyst systems that contain conventional metallocene compounds.

### TECHNICAL FIELD

This disclosure relates generally to heterocene compounds and their use in catalyst compositions for olefin polymerization.

### BACKGROUND

Metallocene compounds can be used in catalyst compositions for the production of olefin polymers. In some end-use applications, it can be beneficial for catalyst compositions and olefin polymerization processes to utilize metallocene compounds that exhibit high catalytic activity and result in desirable polymer characteristics, e.g., higher molecular weights. Accordingly, it is to these ends that the present invention is generally directed.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

The present invention generally relates to new catalyst compositions, processes for using the catalyst compositions to polymerize olefins, the polymer resins produced using such catalyst compositions, and articles produced using these polymer resins. In particular, the present invention relates to metallocene compounds containing a heteroatom-containing cyclopentadienyl-type group (“heterocenes”), and to catalyst compositions employing such heterocene compounds. Catalyst compositions of the present invention that contain these heterocene compounds can be used to produce, for example, ethylene-based homopolymers and copolymers.

In accordance with certain aspects of this disclosure, metallocene compounds disclosed herein can have the formula (A):

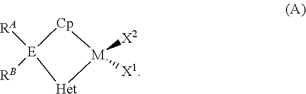

In formula (A), M can be Ti, Zr, or Hf; E can be C, Si, or Ge; Cp can be a substituted or unsubstituted cyclopentadienyl group; X¹ and X² independently can be a monoanionic ligand; R^{A} and R^{B} independently can be H, a C₁ to C₃₆ hydrocarbyl group, a C₁ to C₃₆ hydrocarboxy group, or a C₁ to C₃₆ hydrocarbylsilyl group; and Het is a heteroatom-containing cyclopentadienyl-type ligand. In further aspects, metallocene compounds can have any of formulas (I)-(III):

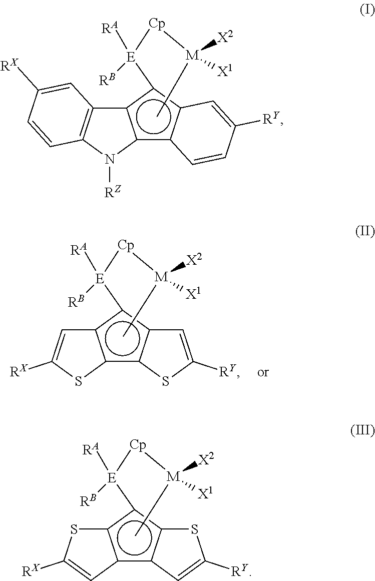

Catalyst compositions containing the heterocene compounds of formulas (A) and (I)-(III) also are provided by the present invention. In one aspect, a catalyst composition is disclosed which comprises a heterocene compound and an activator. Optionally, this catalyst composition can further comprise a co-catalyst, such as an organoaluminum compound. In some aspects, the activator can comprise an activator-support, while in other aspects, the activator can comprise an aluminoxane compound, an organoboron or organoborate compound, an ionizing ionic compound, or combinations thereof.

The present invention also contemplates and encompasses olefin polymerization processes. Such processes can comprise contacting a catalyst composition with an olefin monomer and optionally an olefin comonomer in a polymerization reactor system under polymerization conditions to produce an olefin polymer. Generally, the catalyst composition employed can comprise any of the heterocene compounds disclosed herein and any of the activators disclosed herein. Further, organoaluminum compounds or other co-catalysts also can be utilized in the catalyst compositions and/or polymerization processes.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects and embodiments may be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the compounds, compositions, processes, or methods described herein are contemplated with or without explicit description of the particular combination. Additionally, unless explicitly recited otherwise, any aspect or feature disclosed herein can be combined to describe inventive compounds, compositions, processes, or methods consistent with the present disclosure.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

The term “hydrocarbon” whenever used in this specification and claims refers to a compound containing only carbon and hydrogen, whether saturated or unsaturated. Other identifiers can be utilized to indicate the presence of particular groups in the hydrocarbon (e.g., halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. Moreover, unless otherwise specified, “substituted” is intended to be non-limiting and include inorganic substituents or organic substituents as understood by one of ordinary skill in the art.

The terms “contacting” and “combining” are used herein to describe compositions, processes, and methods in which the materials or components are contacted or combined together in any order, in any manner, and for any length of time, unless otherwise specified. For example, the materials or components can be blended, mixed, slurried, dissolved, reacted, treated, compounded, or otherwise contacted or combined in some other manner or by any suitable method or technique.

While compositions, processes, and methods are described in terms of “comprising” various components or steps, the compositions, processes, and methods also can “consist essentially of” or “consist of” the various components or steps, unless stated otherwise. The terms “a,” “an,” and “the” are intended to include plural alternatives, e.g., at least one, unless otherwise specified.

The term “polymer” is used herein generically to include olefin homopolymers, copolymers, terpolymers, and the like, as well as alloys and blends thereof. The term “polymer” also includes impact, block, graft, random, and alternating copolymers. A copolymer can be derived from an olefin monomer and one olefin comonomer, while a terpolymer can be derived from an olefin monomer and two olefin comonomers. Accordingly, “polymer” encompasses copolymers and terpolymers. Similarly, the scope of the term “polymerization” includes homopolymerization, copolymerization, and terpolymerization. Therefore, an ethylene polymer would include ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, if present and unless stated otherwise, and such configurations can include isotactic, syndiotactic, and random symmetries. The term “polymer” also is meant to include all molecular weight polymers, and is inclusive of lower molecular weight polymers or oligomers.

The term “co-catalyst” is used generally herein to refer to compounds such as aluminoxane compounds, organoboron or organoborate compounds, ionizing ionic compounds, organoaluminum compounds, organozinc compounds, organomagnesium compounds, organolithium compounds, and the like, that can constitute one component of a catalyst composition, when used, for example, in addition to an activator-support. The term “co-catalyst” is used regardless of the actual function of the compound or any chemical mechanism by which the compound may operate.

The term “metallocene” as used herein describes compounds comprising at least one η³ to η⁵-cycloalkadienyl-type moiety, wherein η³ to η⁵-cycloalkadienyl-type moieties include cyclopentadienyl ligands, indenyl ligands, fluorenyl ligands, and the like, including partially saturated or substituted derivatives or analogs of any of these. Possible substituents on these ligands can include H, therefore encompassed herein are ligands such as tetrahydroindenyl, tetrahydrofluorenyl, octahydrofluorenyl, partially saturated indenyl, partially saturated fluorenyl, substituted partially saturated indenyl, substituted partially saturated fluorenyl, and the like. In some contexts, the metallocene is referred to simply as the “catalyst,” in much the same way the term “co-catalyst” is used herein to refer to, for example, an organoaluminum compound.

As used herein, the term “heterocene” describes a subset of the metallocenes as described above which further contain a heteroatom within the at least one η³ to η⁵-cycloalkadienyl-type moiety.

The terms “catalyst composition,” “catalyst mixture,” “catalyst system,” and the like, do not depend upon the actual product or composition resulting from the contact or reaction of the initial components of the disclosed or claimed catalyst composition/mixture/system, the nature of the active catalytic site, or the fate of the co-catalyst or activator or metallocene/heterocene compound after combining these components. Therefore, the terms “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, may be used interchangeably throughout this disclosure.

Various numerical ranges are disclosed herein. When a range of any type is disclosed or claimed, the intent is to disclose or claim individually each possible number that such a range could reasonably encompass, including end points of the range as well as any sub-ranges and combinations of sub-ranges encompassed therein, unless otherwise specified. For example, for any disclosed or claimed chemical moiety having a certain number of carbon atoms, the intent is to disclose or claim individually every possible number that such a range could encompass, consistent with the disclosure herein. For example, the disclosure that a moiety is a C₁ to C₁₈ alkyl group, or in alternative language, an alkyl group having from 1 to 18 carbon atoms, as used herein, refers to a moiety that can have 1, 2, 3, 4, 5, 6, 7, 8, 9, 10, 11, 12, 13, 14, 15, 16, 17, or 18 carbon atoms, as well as any range between these two numbers (for example, a C₁ to C₆ alkyl group), and also including any combination of ranges between these two numbers (for example, a C₂ to C₄ and a C₈ to C₁₂ alkyl group).

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION

The present invention is directed generally to new compounds and new catalyst compositions, methods for preparing the catalyst compositions, methods for using the catalyst compositions to polymerize olefins, the polymer resins produced using such catalyst compositions, and articles produced using these polymer resins. In particular, the present invention relates to heterocyclic metallocene complexes, to catalyst compositions employing these metallocene complexes, to polymerization processes utilizing such catalyst compositions, and to the resulting polymers produced from the polymerization processes.

### Heterocene Compounds

Disclosed herein are metallocene compounds containing at least one η³ to η⁵-cycloalkadienyl-type moiety containing a heteroatom (“heterocenes”) and methods of making these compounds. In certain aspects, heterocene compounds disclosed herein can have the following formula (A):

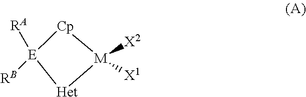

In accordance with aspects of this invention, the metal M in formula (A) (and formulas (I)-(III) shown further below) can be Ti, Zr, or Hf. In one aspect, for instance, M can be Ti or Zr, while in another aspect, M can be Ti; alternatively, M can be Zr; or alternatively, M can be Hf.

In formula (A), Cp and Het each can comprise a cyclopentadienyl-type moiety, and Cp in formulas (I)-(III) shown further below can comprise a cyclopentadienyl-type moiety. In certain aspects, Cp can be a cyclopentadienyl, indenyl, or fluorenyl group, and Het can be a heteroaryl ring system comprising a cyclopentadienyl moiety. In further aspects, Cp can be a cyclopentadienyl, indenyl, or fluorenyl group further comprising a fused heteroaryl ring. Thus, in certain aspects, one or both of Cp and Het can be a can be a heteroaryl ring system comprising a cyclopentadienyl moiety. In certain aspects, Cp and Het independently can be substituted or unsubstituted 4H-cyclopentadithiophene. In other aspects, Cp and Het independently can be a substituted or unsubstituted indenoindole. Exemplary unsubstituted isomers of Cp and Het are shown below.

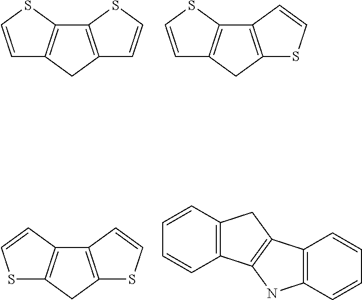

In a further aspect, Cp can be a cyclopentadienyl group, and Het can be a heteroaryl ring system comprising a cyclopentadienyl moiety (e.g., a 4H-cyclopentadithiophene, an indenoindole). In yet another aspect, Cp can be an indenyl group, and Het can be a heteroaryl ring system comprising a cyclopentadienyl moiety. In still another aspect, Cp can be a fluorenyl group, and Het can be a heteroaryl ring system comprising a cyclopentadienyl moiety.

In these and other aspects, Cp can be unsubstituted, or Het can be unsubstituted, or both Cp and Het can be unsubstituted (in this terminology, the bridging group is not considered to be a substitution). Consistent with other aspects of this invention, Cp can be substituted with any suitable substituent, any suitable number of substituents, and at any suitable position(s) that conforms to the rules of chemical valence, and/or Het can be substituted with any suitable substituent, any suitable number of substituents, and at any suitable position(s) that conforms to the rules of chemical valence.

Accordingly, Cp can contain a substituent (one or more) such as H, a halide, a C₁ to C₃₆ hydrocarbyl group, a C₁ to C₃₆ halogenated hydrocarbyl group, a C₁ to C₃₆ hydrocarboxy group, or a C₁ to C₃₆ hydrocarbylsilyl group. Similarly, Het can contain a substituent (one or more) such as H, a halide, a C₁ to C₃₆ hydrocarbyl group, a C₁ to C₃₆ halogenated hydrocarbyl group, a C₁ to C₃₆ hydrocarboxy group, or a C₁ to C₃₆ hydrocarbylsilyl group. Hence, each substituent independently can be H; alternatively, a halide; alternatively, a C₁ to C₁₈ hydrocarbyl group; alternatively, a C₁ to C₁₈ halogenated hydrocarbyl group; alternatively, a C₁ to C₁₈ hydrocarboxy group; alternatively, a C₁ to C₁₈ hydrocarbylsilyl group; alternatively, a C₁ to C₁₂ hydrocarbyl group or a C₁ to C₁₂ hydrocarbylsilyl group; or alternatively, a C₁ to C₈ alkyl group or a C₃ to C₈ alkenyl group. The halide, C₁ to C₃₆ hydrocarbyl group, C₁ to C₃₆ hydrocarboxy group, and C₁ to C₃₆ hydrocarbylsilyl group which can be a substituent on Cp and/or Het can be any halide, C₁ to C₃₆ hydrocarbyl group, C₁ to C₃₆ hydrocarboxy group, and C₁ to C₃₆ hydrocarbylsilyl group described herein (e.g., as pertaining to X¹ and X² in formula (A) and formulas (I)-(III)). A substituent on Cp and/or Het independently can be, in certain aspects, a C₁ to C₃₆ halogenated hydrocarbyl group, where the halogenated hydrocarbyl group indicates the presence of one or more halogen atoms replacing an equivalent number of hydrogen atoms in the hydrocarbyl group. The halogenated hydrocarbyl group often can be a halogenated alkyl group, a halogenated alkenyl group, a halogenated cycloalkyl group, a halogenated aryl group, or a halogenated aralkyl group. Representative and non-limiting halogenated hydrocarbyl groups include pentafluorophenyl, trifluoromethyl (CF₃), and the like.

A substituent on Cp and/or Het independently can be, in certain aspects, an alkyl group or an alkenyl group. As a non-limiting example, each substituent on Cp and/or Het independently can be H, CF₃, a methyl group, an ethyl group, a propyl group, a butyl group (e.g., t-Bu), a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group (or other substituted aryl group), a benzyl group, a naphthyl group, a trimethylsilyl group, a triisopropylsilyl group, a triphenylsilyl group, an allyldimethylsilyl group, or a 1-methylcyclohexyl group; alternatively, H; alternatively, Cl; alternatively, CF₃; alternatively, a methyl group; alternatively, an ethyl group; alternatively, a propyl group; alternatively, a butyl group; alternatively, a pentyl group; alternatively, a hexyl group; alternatively, a heptyl group; alternatively, an octyl group, a nonyl group; alternatively, a decyl group; alternatively, an ethenyl group; alternatively, a propenyl group; alternatively, a butenyl group; alternatively, a pentenyl group; alternatively, a hexenyl group; alternatively, a heptenyl group; alternatively, an octenyl group; alternatively, a nonenyl group; alternatively, a decenyl group; alternatively, a phenyl group; alternatively, a tolyl group; alternatively, a benzyl group; alternatively, a naphthyl group; alternatively, a trimethylsilyl group; alternatively, a triisopropylsilyl group; alternatively, a triphenylsilyl group; alternatively, an allyldimethylsilyl group; or alternatively, a 1-methylcyclohexyl group.

In one aspect, for example, each substituent on Cp and/or Het independently can be H or a C₁ to C₁₈ hydrocarbyl group; alternatively, a C₁ to C₁₀ hydrocarbyl group; alternatively, a C₁ to C₈ linear or branched alkyl group (e.g., a tert-butyl group); alternatively, an alkenyl group (e.g., a C₂ to C₁₈ alkenyl group, a C₂ to C₁₂ alkenyl group, a C₂ to C₈ terminal alkenyl group, a C₃ to C₆ terminal alkenyl group); alternatively, H, Cl, CF₃, a methyl group, an ethyl group, a propyl group, a butyl group (e.g., t-Bu), a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group, a benzyl group, a naphthyl group, a trimethylsilyl group, a triisopropylsilyl group, a triphenylsilyl group, an allyldimethylsilyl group, or a 1-methylcyclohexyl group, and the like; alternatively, a methyl group, an ethyl group, a propyl group, a butyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group, or a benzyl group; alternatively, a methyl group, an ethyl group, a propyl group, a butyl group, a pentyl group, or a hexyl group; alternatively, a methyl group; alternatively, an ethyl group; alternatively, a propyl group; alternatively, a butyl group; or alternatively, a tert-butyl group.

In formula (A) and formulas (I)-(III), Cp can be a cyclopentadienyl group optionally substituted with any substituent (i.e., one or more) disclosed herein, while Het can comprise an alkyl substituent. Further, Cp can be a cyclopentadienyl group substituted with an alkenyl substituent, while Het can comprise an alkyl substituent. In these and other aspects, the respective substituents can be at any suitable position(s) on Cp and Het that conforms to the rules of chemical valence. In some aspects, Cp and/or Het has only one substituent, and that one substituent is an alkyl substituent. In other aspects, Cp and/or Het has only one substituent, and that one substituent is an alkenyl substituent.

While not limited thereto, the alkenyl substituent can be a C₂ to C₁₈ alkenyl group, i.e., any C₂ to C₁₈ alkenyl group disclosed herein. For instance, the alkenyl substituent can be an ethenyl group, a propenyl group, a butenyl group, a pentenyl group, a hexenyl group, a heptenyl group, an octenyl group, a nonenyl group, or a decenyl group. In other aspects, the alkenyl substituent can be a C₂ to C₁₂ linear or branched alkenyl group; alternatively, a C₂ to C₈ linear or branched alkenyl group; alternatively, a C₃ to C₁₂ linear alkenyl group; alternatively, a C₂ to C₈ linear alkenyl group; alternatively, a C₂ to C₈ terminal alkenyl group; alternatively, a C₃ to C₈ terminal alkenyl group; or alternatively, a C₃ to C₆ terminal alkenyl group.

In accordance with non-limiting aspects of this invention, Het can have only alkyl substituents, and Cp can be an cyclopentadienyl that does not contain any substituents; or Het can have an alkyl substituent and one or more other substituents, and Cp can be a cyclopentadienyl group that does not contain an alkenyl substituent, but contains one or more other substituents; or Het can comprise an alkyl substituent and optionally one or more other substituents, and Cp can be a cyclopentadienyl group that does not contain any substituents; or Het can comprise an alkyl substituent, and Cp can be a cyclopentadienyl group that contains an alkenyl substituent and optionally one or more other substituents.

Given the disclosure above, the following heterocene compounds having formulas (I)-(III) are exemplary of formula (A):

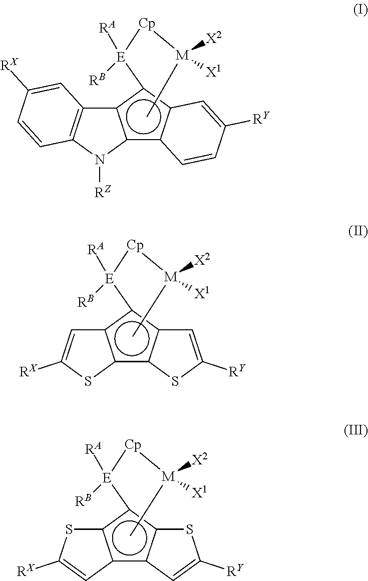

In formulas (I)-(III), substituents R^{X}, R^{Y}, and R^{Z} each may be selected from any substituent noted for Het above that conforms to the rules of chemical valence. In certain aspects, R^{X}, R^{Y}, and R^{Z} independently can be H, or a C₁ to C₃₆ hydrocarbyl group (e.g., a C₁ to C₁₀ hydrocarbyl group). In other aspects, R^{X}, R^{Y}, and R^{Z} independently can be H, a methyl group, an ethyl group, a propyl group, a butyl group (e.g., t-Bu), a pentyl group, a hexyl group, a heptyl group, an octyl group, a nonyl group, a decyl group. As a further non-limiting example of Formula (I), R^{X} and R^{Y} independently can be H, a halide, or a C₁ to C₁₀ hydrocarbyl group, and R^{z} can be methyl.

X¹ and X² in formulas (I)-(III) independently can be a monoanionic ligand. In some aspects, suitable monoanionic ligands can include, but are not limited to, H (hydride), BH₄, a halide, a C₁ to C₃₆ hydrocarbyl group, a C₁ to C₃₆ hydrocarboxy group, a C₁ to C₃₆ hydrocarbylaminyl group, a C₁ to C₃₆ hydrocarbylsilyl group, a C₁ to C₃₆ hydrocarbylaminylsilyl group, —OBR¹₂, or —OSO₂R¹, wherein R¹ is a C₁ to C₃₆ hydrocarbyl group. It is contemplated that X¹ and X² can be either the same or a different monoanionic ligand. Suitable hydrocarbyl groups, hydrocarboxy groups, hydrocarbylaminyl groups, hydrocarbylsilyl groups, and hydrocarbylaminylsilyl groups are disclosed, for example, in U.S. Pat. No. 9,758,600. In one aspect, X¹ and X² independently can be a halide or a C₁ to C₁₈ hydrocarbyl group, while in another aspect, X¹ and X² can be Cl.

The bridging group in formulas (I)-(III) can be a bridging group having the formula >ER^{A}R^{B}, wherein E can be C, Si, or Ge, and R^{A} and R^{B} independently can be H, or a C₁ to C₃₆ hydrocarbyl group, a C₁ to C₃₆ hydrocarboxy group, or a C₁ to C₃₆ hydrocarbylsilyl group. In some aspects of this invention, E can be C, and R^{A} and R^{B} independently can be H or a C₁ to C₁₈ hydrocarbyl group; alternatively, R^{A} and R^{B} independently can be a C₁ to C₈ hydrocarbyl group; alternatively, R^{A} and R^{B} independently can be a phenyl group, a C₁ to C₈ alkyl group, or a C₃ to C₈ alkenyl group; alternatively, R^{A} and R^{B} independently can be a methyl group, an ethyl group, a propyl group, a butyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a cyclohexylphenyl group, a naphthyl group, a tolyl group, or a benzyl group; or alternatively, R^{A} and R^{B} independently can be a methyl group, an ethyl group, a propyl group, a butyl group, a pentyl group, a hexyl group, a propenyl group, a butenyl group, a pentenyl group, a hexenyl group, a phenyl group, or a benzyl group. In these and other aspects, R^{A} and R^{B} can be either the same or different. For instance, in certain aspects, R^{A} and R^{B} each can be phenyl.

Alternatively, R^{A} and R^{B} can be joined to form a bicyclic bridging group connected to Cp and Het, often a C₇ to C₁₈ bicyclic bridging group, a C₇ to C₁₂ bicyclic bridging group, or a C₇ to C₁₀ bicyclic bridging group. In one aspect of this invention, for instance, ER^{A}R^{B} can be a saturated hydrocarbon group, while in another aspect, ER^{A}R^{B} can be an unsaturated hydrocarbon group, and in yet another aspect, ER^{A}R^{B} can be an aromatic hydrocarbon group.

Further examples of heterocene compounds within the scope of Formula (A) and the description of M, Cp, Het, X¹, X², E, R^{A}, R^{B}, R^{X}, R^{Y}, and R^{Z} above are provided below, without limitation. For instance, heterocenes of Formula (I) can include those shown below.

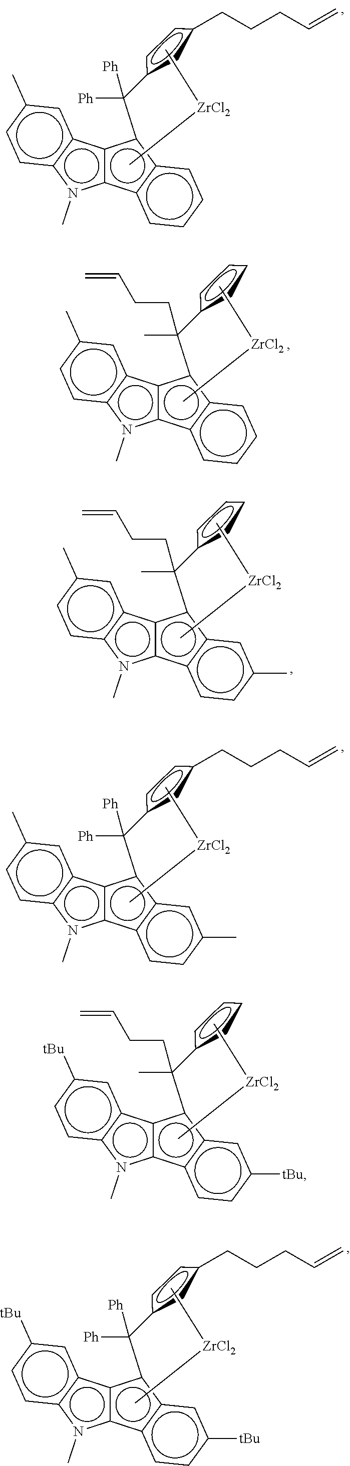

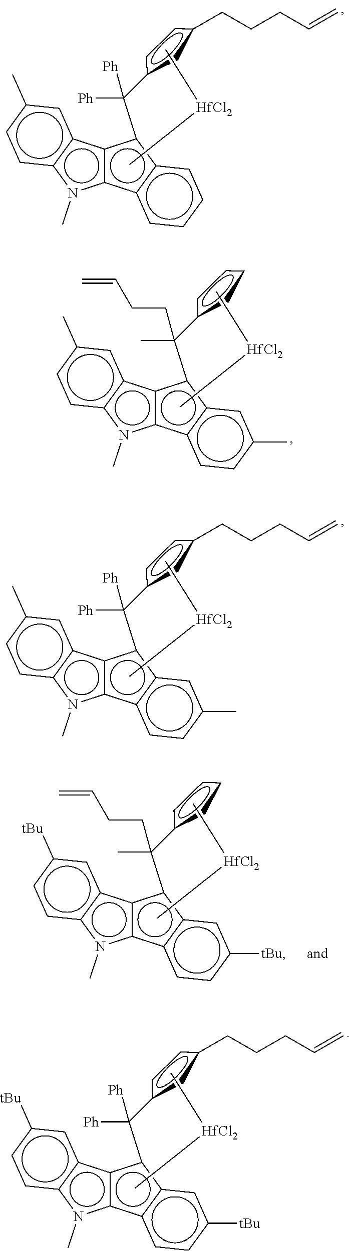

In further examples, heterocenes of Formula (II) can include those shown below.

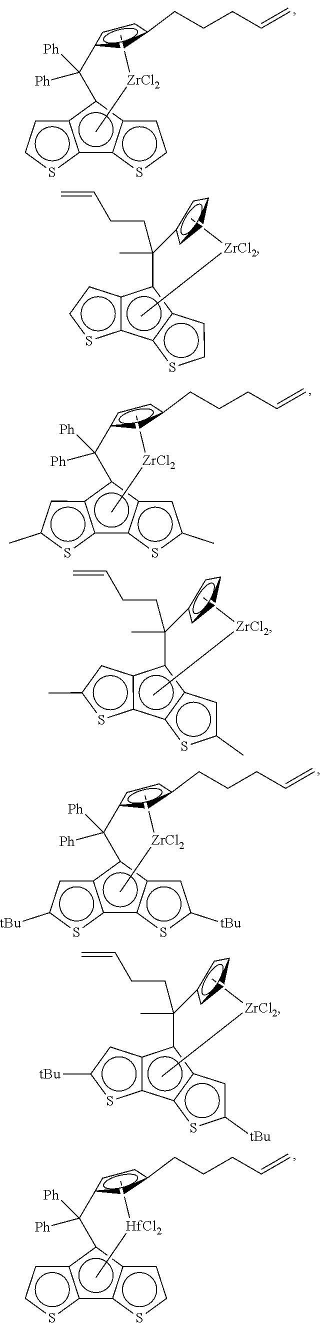

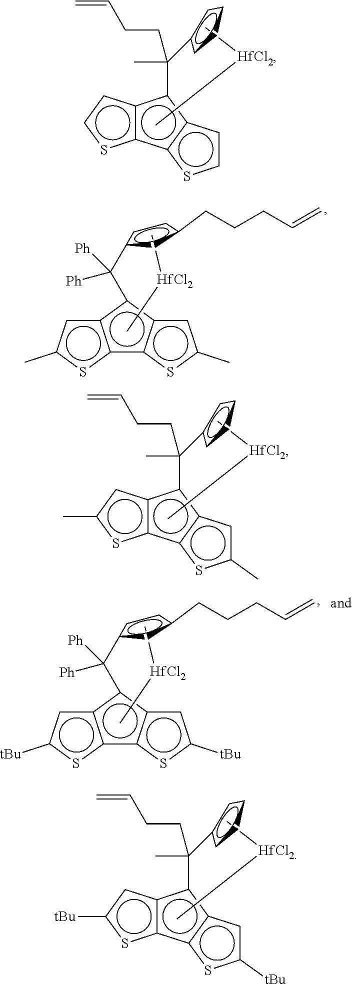

In still further examples, heterocenes of Formula (III) can include those shown below.

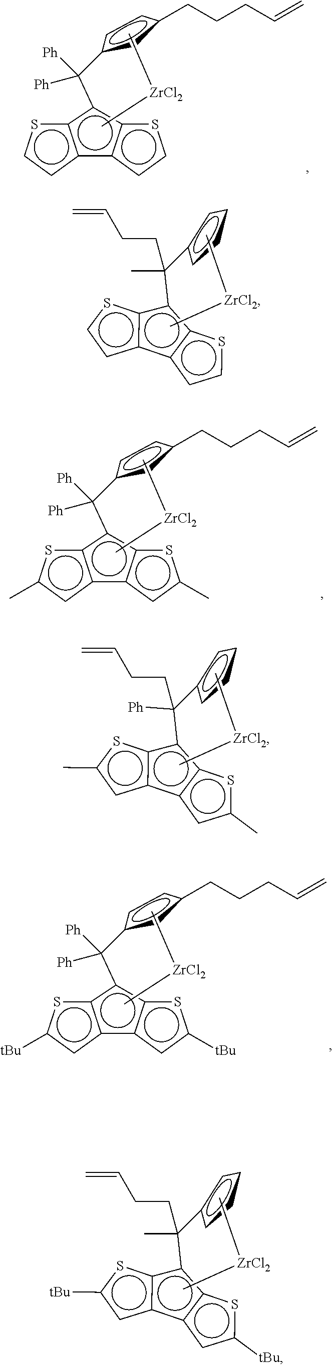

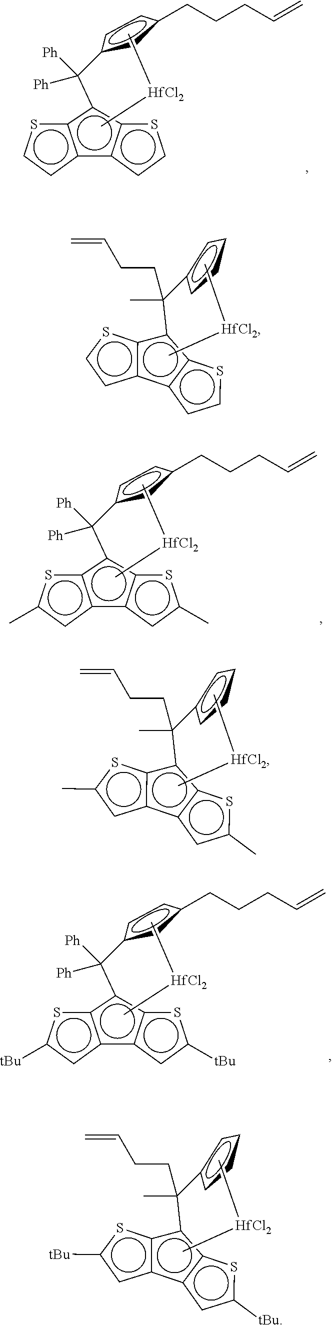

### Catalyst Compositions

In some aspects, the present invention employs catalyst compositions containing a heterocene compound and an activator (one or more than one). These catalyst compositions can be utilized to produce polyolefins—homopolymers, copolymers, and the like—for a variety of end-use applications. Heterocene compounds are discussed hereinabove. In aspects of the present invention, it is contemplated that the catalyst composition can contain more than one heterocene compound. Further, additional catalytic compounds—other than those specified as a heterocene compound—can be employed in the catalyst compositions and/or the polymerization processes, provided that the additional catalytic compound does not detract from the advantages disclosed herein. Additionally, more than one activator also can be utilized.

Generally, catalyst compositions of the present invention comprise a heterocene compound having formulas (I)-(III) and an activator. In aspects of the invention, the activator can comprise an activator-support (e.g., an activator-support comprising a solid oxide treated with an electron-withdrawing anion). Activator-supports useful in the present invention are disclosed herein. Optionally, such catalyst compositions can further comprise one or more than one co-catalyst compound or compounds (suitable co-catalysts, such as organoaluminum compounds, also are discussed herein). Thus, a catalyst composition of this invention can comprise a heterocene compound, an activator-support, and an organoaluminum compound. For instance, the activator-support can comprise (or consist essentially of, or consist of) fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided-chlorided silica-coated alumina, fluorided silica-coated alumina, sulfated silica-coated alumina, phosphated silica-coated alumina, and the like, or combinations thereof, or alternatively, a fluorided solid oxide and/or a sulfated solid oxide. Additionally, the organoaluminum compound can comprise (or consist essentially of, or consist of) trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and the like, or combinations thereof. Accordingly, a catalyst composition consistent with aspects of the invention can comprise (or consist essentially of, or consist of) a heterocene compound; sulfated alumina (or fluorided-chlorided silica-coated alumina, or fluorided silica-coated alumina); and triethylaluminum (or triisobutylaluminum).

In another aspect of the present invention, a catalyst composition is provided which comprises a heterocene compound, an activator-support, and an organoaluminum compound, wherein this catalyst composition is substantially free of aluminoxanes, organoboron or organoborate compounds, ionizing ionic compounds, and/or other similar materials; alternatively, substantially free of aluminoxanes; alternatively, substantially free or organoboron or organoborate compounds; or alternatively, substantially free of ionizing ionic compounds.

In other aspects of this invention, these activators/co-catalysts can be employed. For example, a catalyst composition comprising a heterocene compound and an activator-support can further comprise an optional co-catalyst. Suitable co-catalysts in this aspect can include, but are not limited to, aluminoxane compounds, organoboron or organoborate compounds, ionizing ionic compounds, organoaluminum compounds, organozinc compounds, organomagnesium compounds, organolithium compounds, and the like, or any combination thereof, or alternatively, organoaluminum compounds, organozinc compounds, organomagnesium compounds, organolithium compounds, or any combination thereof. More than one co-catalyst can be present in the catalyst composition. Other suitable co-catalysts are well known to those of skill in the art including, for example, those disclosed in U.S. Pat. Nos. 3,242,099, 4,794,096, 4,808,561, 5,576,259, 5,807,938, 5,919,983, 7,294,599, 7,601,665, 7,884,163, 8,114,946, and 8,309,485.

In a different aspect, a catalyst composition is provided which does not require an activator-support. Such a catalyst composition can comprise a heterocene compound and an activator, wherein the activator can comprise an aluminoxane compound (e.g., a supported aluminoxane), an organoboron or organoborate compound, an ionizing ionic compound, or combinations thereof, alternatively, an aluminoxane compound; alternatively, an organoboron or organoborate compound; or alternatively, an ionizing ionic compound.

In a particular aspect contemplated herein, the catalyst composition is a catalyst composition comprising an activator (one or more than one) and only one heterocene compound having formulas (I)-(III). In these and other aspects, the catalyst composition can comprise an activator (e.g., an activator-support comprising a solid oxide treated with an electron-withdrawing anion), only one heterocene compound, and a co-catalyst (one or more than one), such as an organoaluminum compound.

Generally, the weight ratio of organoaluminum compound to activator-support can be in a range from 10:1 to 1:1000. If more than one organoaluminum compound and/or more than one activator-support are employed, this ratio is based on the total weight of each respective component. In another aspect, the weight ratio of the organoaluminum compound to the activator-support can be in a range from 3:1 to 1:500, or from 1:10 to 1:350.

In some aspects of this invention, the weight ratio of heterocene compound to activator-support can be in a range from 1:1 to 1:1,000,000. If more than one metallocene compound and/or more than activator-support is/are employed, this ratio is based on the total weights of the respective components. In another aspect, this weight ratio can be in a range from 1:5 to 1:100,000, or from 1:10 to 1:10,000. Yet, in another aspect, the weight ratio of the heterocene compound to the activator-support can be in a range from 1:20 to 1:1000.

Catalyst compositions of the present invention generally have a catalyst activity greater than 50,000 grams, greater than 75,000 grams, greater than 100,000 grams, greater than 125,000 grams, etc., of ethylene polymer (homopolymer or copolymer, as the context requires) per gram of the heterocene compound per hour (abbreviated g/g/h). In another aspect, the catalyst activity can be greater than 150,000, greater than 175,000, or greater than 200,000 g/g/h, and often can range up to 500,000-2,000,000 g/g/h. These activities are measured under slurry polymerization conditions, with a triisobutylaluminum co-catalyst, using isobutane as the diluent, at a polymerization temperature of 80° C. and a reactor pressure of 340 psig. Additionally, in some aspects, the activator can comprise an activator-support, such as sulfated alumina, fluorided-chlorided silica-coated alumina, or fluorided silica-coated alumina, although not limited thereto. Non-limiting examples of suitable activator-supports are disclosed in, for instance, U.S. Pat. Nos. 7,294,599, 7,601,665, 7,884,163, 8,309,485, 8,623,973, 8,703,886, and 9,023,959.

Catalyst compositions of the present invention may also be characterized in relative sense based on their activity as compared to catalyst compositions containing metallocene compounds that do not have a heteroatom within a cyclopentadienyl-type group coordinated to the metal. For instance, catalyst compositions comprising a heterocene compound disclosed herein can have an activity that is greater than that of a catalyst composition comprising an otherwise identical metallocene compound that does not comprise a heteroatom within the aromatic system of a cyclopentadienyl-type group (e.g., substituted or unsubstituted cyclopentadienyl, indenyl, and fluorenyl groups). In certain aspects, the activity of the heterocene-containing catalyst compositions can be greater by any amount disclosed herein, e.g., at least 10%, at least 15%, at least 20%, at least 30%, or at least 35%, up to 50%, 60%, 75%, or 100%. Alternatively, the activity of the heterocene-containing catalyst compositions can be in a range from 5% to 500% greater, from 10% to 250% greater, or from 25% to 100%, greater than that of an otherwise identical metallocene compound that does not comprise a heteroatom within the aromatic system of a cyclopentadienyl group.

### Polymerization Processes

Catalyst compositions of the present invention can be used to polymerize olefins to form homopolymers, copolymers, terpolymers, and the like. One such process for polymerizing olefins in the presence of a catalyst composition of the present invention can comprise contacting the catalyst composition with an olefin monomer and optionally an olefin comonomer (one or more) in a polymerization reactor system under polymerization conditions to produce an olefin polymer, wherein the catalyst composition can comprise any of the catalyst compositions described herein. For instance, the catalyst composition can comprise a heterocene having any of formulas (I)-(III) and an activator. The components of the catalyst compositions are described herein.

The catalyst compositions of the present invention are intended for any olefin polymerization method using various types of polymerization reactor systems and reactors. The polymerization reactor system can include any polymerization reactor capable of polymerizing olefin monomers and comonomers (one or more than one comonomer) to produce homopolymers, copolymers, terpolymers, and the like. The various types of reactors include those that can be referred to as a batch reactor, slurry reactor, gas-phase reactor, solution reactor, high pressure reactor, tubular reactor, autoclave reactor, and the like, or combinations thereof. Suitable polymerization conditions are used for the various reactor types. Gas phase reactors can comprise fluidized bed reactors or staged horizontal reactors. Slurry reactors can comprise vertical or horizontal loops. High pressure reactors can comprise autoclave or tubular reactors. Reactor types can include batch or continuous processes. Continuous processes can use intermittent or continuous product discharge. Processes can also include partial or full direct recycle of unreacted monomer, unreacted comonomer, and/or diluent.

Polymerization reactor systems of the present invention can comprise one type of reactor in a system or multiple reactors of the same or different type (e.g., a single reactor, dual reactor, more than two reactors). Production of polymers in multiple reactors can include several stages in at least two separate polymerization reactors interconnected by a transfer device making it possible to transfer the polymers resulting from the first polymerization reactor into the second reactor. The desired polymerization conditions in one of the reactors can be different from the operating conditions of the other reactor(s). Alternatively, polymerization in multiple reactors can include the manual transfer of polymer from one reactor to subsequent reactors for continued polymerization. Multiple reactor systems can include any combination including, but not limited to, multiple loop reactors, multiple gas phase reactors, a combination of loop and gas phase reactors, multiple high pressure reactors, or a combination of high pressure with loop and/or gas phase reactors. The multiple reactors can be operated in series, in parallel, or both. Accordingly, the present invention encompasses polymerization reactor systems comprising a single reactor, comprising two reactors, and comprising more than two reactors. The polymerization reactor system can comprise a slurry reactor, a gas-phase reactor, a solution reactor, in certain aspects of this invention, as well as multi-reactor combinations thereof.

According to one aspect of the invention, the polymerization reactor system can comprise at least one loop slurry reactor comprising vertical or horizontal loops. Monomer, diluent, catalyst, and comonomer can be continuously fed to a loop reactor where polymerization occurs. Generally, continuous processes can comprise the continuous introduction of monomer/comonomer, a catalyst, and a diluent into a polymerization reactor and the continuous removal from this reactor of a suspension comprising polymer particles and the diluent. Reactor effluent can be flashed to remove the solid polymer from the liquids that comprise the diluent, monomer and/or comonomer. Various technologies can be used for this separation step including, but not limited to, flashing that can include any combination of heat addition and pressure reduction, separation by cyclonic action in either a cyclone or hydrocyclone, or separation by centrifugation.

A typical slurry polymerization process (also known as the particle form process) is disclosed, for example, in U.S. Pat. Nos. 3,248,179, 4,501,885, 5,565,175, 5,575,979, 6,239,235, 6,262,191, 6,833,415, and 8,822,608.

Suitable diluents used in slurry polymerization include, but are not limited to, the monomer being polymerized and hydrocarbons that are liquids under reaction conditions. Examples of suitable diluents include, but are not limited to, hydrocarbons such as propane, cyclohexane, isobutane, n-butane, n-pentane, isopentane, neopentane, and n-hexane. Some loop polymerization reactions can occur under bulk conditions where no diluent is used, such as can be employed in the bulk polymerization of propylene to form polypropylene homopolymers.

According to yet another aspect, the polymerization reactor system can comprise at least one gas phase reactor (e.g., a fluidized bed reactor). Such reactor systems can employ a continuous recycle stream containing one or more monomers continuously cycled through a fluidized bed in the presence of the catalyst under polymerization conditions. A recycle stream can be withdrawn from the fluidized bed and recycled back into the reactor. Simultaneously, an ethylene polymer effluent stream can be withdrawn from the reactor and new or fresh monomer can be added to replace the polymerized monomer. Such gas phase reactors can comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone. One type of gas phase reactor is disclosed in U.S. Pat. Nos. 5,352,749, 4,588,790, 5,436,304, 7,531,606, and 7,598,327.

According to still another aspect of the invention, a high pressure polymerization reactor can comprise a tubular reactor or an autoclave reactor. Tubular reactors can have several zones where fresh monomer, initiators, or catalysts are added. Monomer can be entrained in an inert gaseous stream and introduced at one zone of the reactor. Initiators, catalysts, and/or catalyst components can be entrained in a gaseous stream and introduced at another zone of the reactor. The gas streams can be intermixed for polymerization. Heat and pressure can be employed appropriately to obtain optimal polymerization reaction conditions.

According to yet another aspect of the invention, the polymerization reactor system can comprise a solution polymerization reactor wherein the monomer (and comonomer, if used) are contacted with the catalyst composition by suitable stirring or other means. A carrier comprising an inert organic diluent or excess monomer can be employed. If desired, the monomer/comonomer can be brought in the vapor phase into contact with the catalytic reaction product, in the presence or absence of liquid material. The polymerization zone is maintained at temperatures and pressures that will result in the formation of a solution of the polymer in a reaction medium. Agitation can be employed to obtain better temperature control and to maintain uniform polymerization mixtures throughout the polymerization zone. Adequate means are utilized for dissipating the exothermic heat of polymerization.

Polymerization reactor systems suitable for the present invention can further comprise any combination of at least one raw material feed system, at least one feed system for catalyst or catalyst components, and/or at least one polymer recovery system. Suitable reactor systems for the present invention can further comprise systems for feedstock purification, catalyst storage and preparation, extrusion, reactor cooling, polymer recovery, fractionation, recycle, storage, loadout, laboratory analysis, and process control.

Polymerization conditions that are controlled for efficiency and to provide desired polymer properties can include temperature, pressure, and the concentrations of various reactants. Polymerization temperature can affect catalyst productivity, polymer molecular weight, and molecular weight distribution. A suitable polymerization temperature can be from 60° C. to 280° C., for example, or from 60° C. to 120° C., depending upon the type of polymerization reactor(s). In some reactor systems, the polymerization temperature generally can fall within a range from 70° C. to 100° C., or from 75° C. to 95° C. Various polymerization conditions can be held substantially constant, for example, for the production of a particular grade of olefin polymer.

Suitable pressures will also vary according to the reactor and polymerization type. The pressure for liquid phase polymerizations in a loop reactor is typically less than 1000 psig (6.9 MPa). Pressure for gas phase polymerization is usually at 200 to 500 psig (1.4 MPa to 3.4 MPa). High pressure polymerization in tubular or autoclave reactors is generally run at 20,000 to 75,000 psig (138 to 517 MPa). Polymerization reactors can also be operated in a supercritical region occurring at generally higher temperatures and pressures. Operation above the critical point of a pressure/temperature diagram (supercritical phase) may offer advantages.

Aspects of this invention also are directed to olefin polymerization processes conducted in the absence of added hydrogen. An olefin polymerization process of this invention can comprise contacting a catalyst composition (i.e., any catalyst composition disclosed herein) with an olefin monomer and optionally an olefin comonomer in a polymerization reactor system under polymerization conditions to produce an olefin polymer, wherein the polymerization process is conducted in the absence of added hydrogen (no hydrogen is added to the polymerization reactor system). As one of ordinary skill in the art would recognize, hydrogen can be generated in-situ by catalyst compositions in various olefin polymerization processes, and the amount generated can vary depending upon the specific catalyst components employed, the type of polymerization process used, the polymerization reaction conditions utilized, and so forth.

In other aspects, it may be desirable to conduct the polymerization process in the presence of a certain amount of added hydrogen. Accordingly, an olefin polymerization process of this invention can comprise contacting a catalyst composition (i.e., any catalyst composition disclosed herein) with an olefin monomer and optionally an olefin comonomer in a polymerization reactor system under polymerization conditions to produce an olefin polymer, wherein the polymerization process is conducted in the presence of added hydrogen (hydrogen is added to the polymerization reactor system). For example, the ratio of hydrogen to the olefin monomer in the polymerization process can be controlled, often by the feed ratio of hydrogen to the olefin monomer entering the reactor. The added hydrogen to olefin monomer ratio in the process can be controlled at a weight ratio which falls within a range from 25 ppm to 1500 ppm, from 50 to 1000 ppm, or from 100 ppm to 750 ppm.

In some aspects of this invention, the feed or reactant ratio of hydrogen to olefin monomer can be maintained substantially constant during the polymerization run for a particular polymer grade. That is, the hydrogen:olefin monomer ratio can be selected at a particular ratio within a range from 5 ppm up to 1000 ppm or so, and maintained at the ratio to within +/−25% during the polymerization run. For instance, if the target ratio is 100 ppm, then maintaining the hydrogen:olefin monomer ratio substantially constant would entail maintaining the feed ratio between 75 ppm and 125 ppm. Further, the addition of comonomer (or comonomers) can be, and generally is, substantially constant throughout the polymerization run for a particular polymer grade.

However, in other aspects, it is contemplated that monomer, comonomer (or comonomers), and/or hydrogen can be periodically pulsed to the reactor, for instance, in a manner similar to that employed in U.S. Pat. No. 5,739,220 and U.S. Patent Publication No. 2004/0059070.

The concentration of the reactants entering the polymerization reactor system can be controlled to produce resins with certain physical and mechanical properties. The proposed end-use product that will be formed by the polymer resin and the method of forming that product ultimately can determine the desired polymer properties and attributes. Mechanical properties include tensile, flexural, impact, creep, stress relaxation, and hardness tests. Physical properties include density, molecular weight, molecular weight distribution, melting temperature, glass transition temperature, density, stereoregularity, crack growth, long chain branching, and rheological measurements.

### Olefin Monomers

Unsaturated reactants that can be employed with catalyst compositions and polymerization processes of this invention typically can include olefin compounds having from 2 to 30 carbon atoms per molecule and having at least one olefinic double bond. This invention encompasses homopolymerization processes using a single olefin such as ethylene or propylene, as well as copolymerization, terpolymerization, etc., reactions using an olefin monomer with at least one different olefinic compound. For example, the resultant ethylene copolymers, terpolymers, etc., generally can contain a major amount of ethylene (>50 mole percent) and a minor amount of comonomer (<50 mole percent), though this is not a requirement. Comonomers that can be copolymerized with ethylene often can have from 3 to 20 carbon atoms, or from 3 to 10 carbon atoms, in their molecular chain.

Acyclic, cyclic, polycyclic, terminal (a), internal, linear, branched, substituted, unsubstituted, functionalized, and non-functionalized olefins can be employed in this invention. For example, typical unsaturated compounds that can be polymerized with the catalyst compositions of this invention can include, but are not limited to, ethylene, propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-hexene, 3-ethyl-1-hexene, 1-heptene, 2-heptene, 3-heptene, the four normal octenes (e.g., 1-octene), the four normal nonenes, the five normal decenes, and the like, or mixtures of two or more of these compounds. Cyclic and bicyclic olefins, including but not limited to, cyclopentene, cyclohexene, norbornylene, norbornadiene, and the like, also can be polymerized as described herein. Styrene can also be employed as a monomer in the present invention. In an aspect, the olefin monomer can comprise a C₂-C₂₀ olefin; alternatively, a C₂-C₂₀ alpha-olefin; alternatively, a C₂-C₁₀ olefin; alternatively, a C₂-C₁₀ alpha-olefin; alternatively, the olefin monomer can comprise ethylene; or alternatively, the olefin monomer can comprise propylene.

When a copolymer (or alternatively, a terpolymer) is desired, the olefin monomer and the olefin comonomer independently can comprise, for example, a C₂-C₂₀ alpha-olefin. In some aspects, the olefin monomer can comprise ethylene or propylene, which is copolymerized with at least one comonomer (e.g., a C₂-C₂₀ alpha-olefin, a C₃-C₂₀ alpha-olefin, etc.). According to one aspect of this invention, the olefin monomer used in the polymerization process can comprise ethylene. In this aspect, examples of suitable olefin comonomers can include, but are not limited to, propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, and the like, or combinations thereof. According to another aspect of the present invention, the olefin monomer can comprise ethylene, and the comonomer can comprise a C₃-C₁₀ alpha-olefin; alternatively, the comonomer can comprise 1-butene, 1-pentene, 1-hexene, 1-octene, 1-decene, styrene, or any combination thereof; alternatively, the comonomer can comprise 1-butene, 1-hexene, 1-octene, or any combination thereof; alternatively, the comonomer can comprise 1-butene; alternatively, the comonomer can comprise 1-hexene; or alternatively, the comonomer can comprise 1-octene.

Generally, the amount of comonomer introduced into a polymerization reactor system to produce a copolymer can be from 0.01 to 50 weight percent of the comonomer based on the total weight of the monomer and comonomer. According to another aspect of the present invention, the amount of comonomer introduced into a polymerization reactor system can be from 0.01 to 40 weight percent comonomer based on the total weight of the monomer and comonomer. In still another aspect, the amount of comonomer introduced into a polymerization reactor system can be from 0.1 to 35 weight percent comonomer based on the total weight of the monomer and comonomer. Yet, in another aspect, the amount of comonomer introduced into a polymerization reactor system can be from 0.5 to 20 weight percent comonomer based on the total weight of the monomer and comonomer.

While not intending to be bound by this theory, where branched, substituted, or functionalized olefins are used as reactants, it is believed that a steric hindrance can impede and/or slow the polymerization process. Thus, branched and/or cyclic portion(s) of the olefin removed somewhat from the carbon-carbon double bond would not be expected to hinder the reaction in the way that the same olefin substituents situated more proximate to the carbon-carbon double bond might.

According to one aspect of the present invention, at least one monomer/reactant can be ethylene (or propylene), so the polymerization reaction can be a homopolymerization involving only ethylene (or propylene), or a copolymerization with a different acyclic, cyclic, terminal, internal, linear, branched, substituted, or unsubstituted olefin. In addition, the catalyst compositions of this invention can be used in the polymerization of diolefin compounds including, but not limited to, 1,3-butadiene, isoprene, 1,4-pentadiene, and 1,5-hexadiene.

### Polymers and Articles

This invention is also directed to, and encompasses, the olefin polymers (e.g., ethylene homopolymers and ethylene/α-olefin copolymers) produced by any of the polymerization processes disclosed herein. Articles of manufacture can be formed from, and/or can comprise, the polymers produced in accordance with this invention.

Generally, olefin polymers encompassed herein can include any polymer produced from any olefin monomer and comonomer(s) described herein. For example, the olefin polymer can comprise an ethylene homopolymer, a propylene homopolymer, an ethylene copolymer (e.g., ethylene/α-olefin, ethylene/1-butene, ethylene/1-hexene, ethylene/1-octene, etc.), a propylene-based copolymer, an ethylene terpolymer, a propylene terpolymer, and the like, including combinations thereof. In one aspect, the olefin polymer can comprise an ethylene homopolymer, an ethylene/1-butene copolymer, an ethylene/1-hexene copolymer, an ethylene/1-octene copolymer, or any combination thereof, while in another aspect, the olefin polymer can comprise an ethylene/1-hexene copolymer.

If the resultant polymer produced in accordance with the present invention is, for example, an ethylene polymer, its properties can be characterized by various analytical techniques known and used in the polyolefin industry. Articles of manufacture can be formed from, and/or can comprise, the ethylene polymers of this invention, whose typical properties are provided below.

The densities of ethylene-based polymers (e.g., ethylene homopolymers, ethylene copolymers) produced using the catalyst systems and processes disclosed herein often are less than or equal to 0.96 g/cm³, for example, less than or equal to 0.945 g/cm³, and often can range down to 0.895 g/cm³. Yet, in particular aspects, the density can be in a range from 0.90 to 0.96, such as, for example, from 0.90 to 0.95, from 0.91 to 0.945, from 0.91 to 0.94, from 0.92 to 0.95, or from 0.915 to 0.935 g/cm³.

In an aspect, ethylene polymers described herein can have a weight-average molecular weight (Mw) in a range from 100,000 to 2,500,000, from 150,000 to 1,000,000, from 125,000 to 500,000, or from 150,000 to 400,000 g/mol.

Olefin polymers, whether homopolymers, copolymers, and so forth, can be formed into various articles of manufacture. Articles which can comprise polymers of this invention include, but are not limited to, an agricultural film, an automobile part, a bottle, a container for chemicals, a drum, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier, and the like. Various processes can be employed to form these articles. Non-limiting examples of these processes include injection molding, blow molding, rotational molding, film extrusion, sheet extrusion, profile extrusion, thermoforming, and the like. Additionally, additives and modifiers are often added to these polymers in order to provide beneficial polymer processing or end-use product attributes. Such processes and materials are described in Modern Plastics Encyclopedia, Mid-November 1995 Issue, Vol. 72, No. 12; and Film Extrusion Manual—Process, Materials, Properties, TAPPI Press, 1992. In some aspects of this invention, an article of manufacture can comprise any of ethylene polymers described herein, and the article of manufacture can be a film product or a molded product.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Density was determined in grams per cubic centimeter (g/cm³) on a compression molded sample, cooled at 15° C. per minute, and conditioned for 40 hr at room temperature in accordance with ASTM D1505 and ASTM D4703.

Molecular weights and molecular weight distributions were obtained using a PL-GPC 220 (Polymer Labs, an Agilent Company) system equipped with a IR4 detector (Polymer Char, Spain) and three Styragel HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were in the range of 1.0-1.5 mg/mL, depending on the molecular weight. Sample preparation was conducted at 150° C. for nominally 4 hr with occasional and gentle agitation, before the solutions were transferred to sample vials for injection. An injection volume of 200 μL was used. The integral calibration method was used to deduce molecular weights and molecular weight distributions using a Chevron Phillips Chemical Company's HDPE polyethylene resin, MARLEX® BHB5003, as the broad standard. The integral table of the broad standard was pre-determined in a separate experiment with SEC-MALS. Mn is the number-average molecular weight, Mw is the weight-average molecular weight, Mz is the z-average molecular weight, My is viscosity-average molecular weight, and Mp is the peak molecular weight (location, in molecular weight, of the highest point of the molecular weight distribution curve).

### Example 1

Ligand L1 shown below was prepared by combining 1-indanone (15 g. 114 mmol) and p-tolylhydrazine hydrochloride (18 g, 114 mmol) in EtOH (150 mL) and aqueous HCl (12 N, 10 mL). The mixture was stirred and heated to reflux for 90 min under nitrogen atmosphere. The mixture was cooled and filtered, and the solid was washed with EtOH (300 mL) and then by 20% aqueous EtOH (200 mL), and finally by hexane (100 mL). The off-white solid was dried under vacuum (70%) yield.

The product from the previous step (13 g, 59 mmol), aqueous NaOH solution (40 mL, 20 M, 0.8 mol), cetrimonium bromide (0.23 g, 0.63 mmol), and toluene (40 mL) were mixed with vigorous stirring at room temperature. A solution of Mel (6 mL, 97 mmol) in toluene (5 mL) was added to the mixture dropwise, and the mixture was then stirred at room temperature for 4 h and refluxed for 3 h. A crystalline solid forms upon cooling and was filtered and washed with cold (−78° C.) EtOH (150 mL) and then with hexane (50 mL). The filtrate separated into two layers. The aqueous fraction was washed twice with toluene (100 mL each time). The organic layers were combined and dried over Mg₂SO₄, then filtered. The volatiles were removed under vacuum and the precipitate was dried and combined with the crystalline product (65%).

A 100 mL Schlenk flask was charged with N-methylindeno[1,2-b]indole (1.8 g, 7.8 mmol) in diethyl ether (10 mL) and toluene (10 mL). After cooling the flask for few hours in the freezer, n-Butyllithium (3.3 mL, 2.5 M, 8.2 mmol) was added dropwise. The mixture was stirred at room temperature overnight. After cooling the mixture again, 6,6-diphenyl-3-(5-pentenyl)-fulvene (1.16 g, 3.9 mmol) in diethyl ether (10 mL) was added dropwise over 30 minutes. The mixture was allowed to reach room temperature and stirred. Reaction progress was monitored by thin layer chromatography (TLC). A saturated aqueous ammonium chloride solution was added to quench the reaction. The solution was extracted with diethyl ether, dried over Mg₂SO₄, volatiles are removed under vacuum and the product was dried further under vacuum. The ligand was then isolated by flash chromatography (63%).

The isolated ligand L1 (0.2 g, 0.377 mmol) was weighed into a 100 mL 2-neck round-bottomed flask, dissolved in 10 mL of diethyl ether, and cooled in an ice water bath. Next, n-BuLi (2.5 M in hexane, 0.32 mL, 0.790 mmol) was added dropwise to the flask, resulting in a pale yellow solution. The reaction mixture was stirred and warmed to room temperature overnight. Then, a suspension of ZrCl₄ (0.096 g, 0.414 mmol) in pentane (5 mL) was slowly added to the ligand solution. After few hours, the volatiles from this mixture were removed in vacuo, redissolved in dichloromethane and centrifuged. The supernatant was transferred to a Schlenk flask and the solvent is removed to obtain a purple solid.

NMR analysis of this product indicated formation of H1. ¹H-NMR (CD₂Cl₂): 8.2-7.7 (m, 4H), 7.7-6.8 (m, 10H), 6.3 (m, 1H), 6.0 (m, 1H), 5.9 (m, 1H), 5.8 (m, 1H), 5.5 (m, 1H), 5.2 (m, 1H), 5.2-4.7 (m, 3H), 4.1 (s, 3H, CH₃), 2.5-1.4 (m, 6H, CH₂), 2.0 (s, 3H, CH₃).

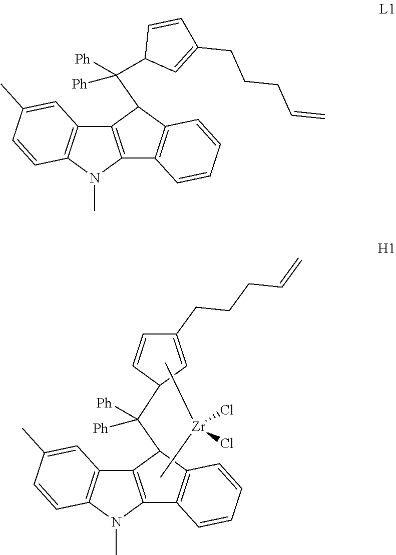

### Example 2

Heterocene H2 was prepared generally as described above for Example 1, substituting the fulvene reactant used in the preparation of L1 with 6-methyl-6-(4-butenyl)-fulvene (0.607 g, 4.15 mmol) to produce Ligand L2 shown below (10% yield). Ligand L2 was then used in the preparation of H2 (50%), according to the procedure of Example 1. ¹H-NMR (CD₂Cl₂): 8.1-6.8 (m, 6H), 6.3 (m, 1H), 6.2 (m, 1H), 6.0 (m, 1H), 5.8 (m, 1H), 5.5 (m, 1H), 5.2-5.0 (m, 3H), 4.2 (s, 3H, CH₃), 2.6 (s, 3H, CH₃), 2.4 (s, 3H, CH₃), 2.8-2.2 (m, 4H, CH₂).

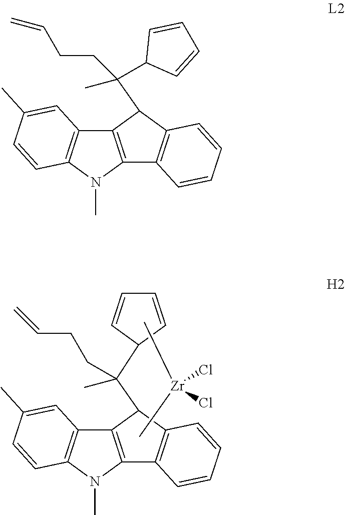

### Example 3

Heterocene H3 was prepared generally as described above for Example 1, substituting the fulvene reactant used in the preparation of L1 with 6,6-dimethylfulvene (3.0 g, 13.0 mmol) to produce Ligand L3, shown below (45%). Ligand L3 was then used in the preparation of H3 (82%), according to the procedure of Example 1. ¹H-NMR (CD₂Cl₂): 8.1 (m, 2H), 7.9 (m, 2H), 7.6 (m, 1H), 7.5 (m, 1H), 7.4-7.2 (m, 8H), 6.8 (m, 1H), 6.4 (m, 1H), 6.3 (m, 1H), 6.2 (m, 1H), 5.8 (m, 1H), 5.5 (m, 1H), 5.0 (s, 1H), 4.2 (s, 3H, CH₃), 2.2 (s, 3H, CH₃).

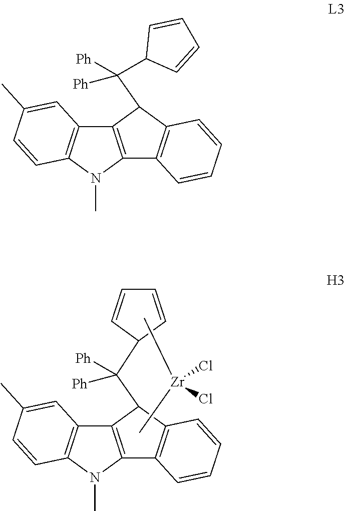

### Example 4

Ligand L4 was prepared by charging a 100 mL Schlenk flask with 4H-cyclopenta[1,2-b:5,4-b′]dithiophene (0.591 g, 3.32 mmol) in diethyl ether (20 mL). After cooling the flask for few hours in the freezer, n-Butyllithium (1.5 mL, 2.5 M, 3.6 mmol) was added dropwise. The mixture was stirred at room temperature overnight. After cooling the mixture again, 6,6-diphenyl-3-(5-pentenyl)-fulvene (0.9 g, 3.0 mmol) in diethyl ether (10 mL) was added dropwise over 30 minutes. The mixture was allowed to reach room temperature and stirred. Reaction progress was monitored by thin layer chromatography (TLC). A saturated aqueous ammonium chloride solution was added to quench the reaction. The solution was extracted with diethyl ether, dried over Mg₂SO₄, the volatiles were removed under vacuum and the product was dried further under vacuum. Ligand L4 was then isolated from the crude product by flash chromatography (60%).

Ligand L4 was then used in the preparation of H4 (37%), according to the procedure of Example 1. ¹H-NMR (CD₂Cl₂): 7.8 (m, 4H, Ph), 7.4 (m, 6H, Ph), 7.2 (m, 2H, Cps-H), 6.3 (m, 1H, Cp-H), 5.8 (m, 3H, Cps-H and ═CH—), 5.6 (m, 1H, Cp-H), 5.4 (m, 1H, Cp-H), 5.0 (dd, 2H, ═CH₂), 2.5 (m, 2H, CH₂), 2.2 (m, 2H, CH₂), 1.7 (m, 2H, CH₂).

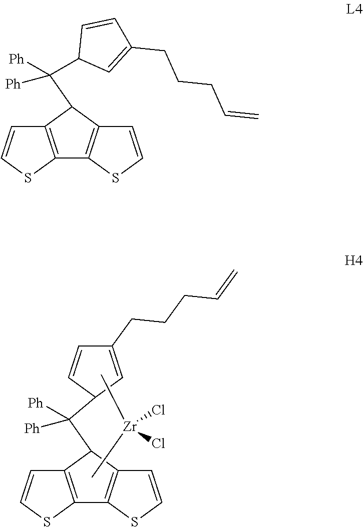

### Example 5

Heterocene H5 was prepared generally as described above for Example 4, substituting the fulvene reactant used in the preparation of L4 with 6-methyl-6-(4-butenyl)-fulvene (1.1 g, 7.4 mmol) to produce Ligand L5, shown below (28%). Ligand L5 was then used in the preparation of H5 (71%), according to the procedure of Example 4. ¹H-NMR (CD₂Cl₂): 7.3 (m, 2H, Cps-H), 7.0 (m, 2H, Cps-H), 6.5 (m, 2H, Cp-H), 6.2 (m, 1H, ═CH—), 5.7 (m, 2H, Cp-H), 5.2 (dd, 2H, ═CH₂), 2.8-2.3 (m, 4H, CH₂), 2.2 (s, 3H, CH₃).

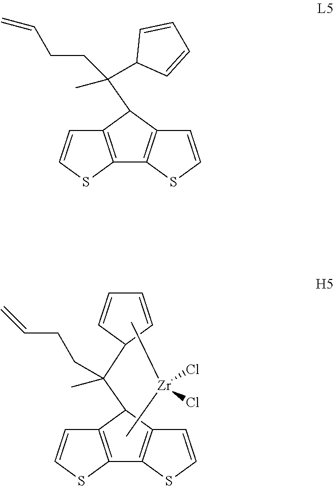

### Example 6

Heterocene H6 was prepared generally as described above for Example 4, substituting the fulvene reactant used in the preparation of L4 with 6,6-diphenylfulvene (2.53 g mL, 11 mmol) to produce Ligand L6, shown below (34%). Ligand L6 was then used in the preparation of H6 (46%), according to the procedure of Example 4. ¹H-NMR (CD₂Cl₂): 7.8 (m, 4H, Ph), 7.4 (m, 6H, Ph), 7.2 (m, 2H, Cps-H), 6.6 (s, 2H, Cp-H), 5.8 (m, 2H, Cps-H), 5.7 (s, 2H, Cp-H).

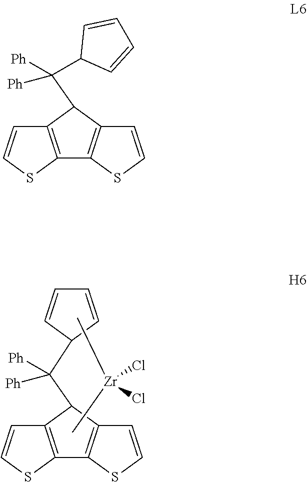

### Examples 7-16

Examples 7-16 were performed using the following polymerization procedure. All polymerization runs were conducted in a one-gallon stainless steel reactor. A supported heterocene compound (heterocenes H1-H6 as shown above) or metallocene compound (comparative metallocenes MET-A and MET-B shown below) was prepared by loading an amount of the heterocene or metallocene compound onto a fluorided silica-coated alumina activator-support at a mass ratio of 100:1. A one-liter, stainless-steel reactor was charged with isobutane (500 mL), 1-hexene (20 g), and triisobutylaluminum (0.4 mL of 1.0 M solution in hexane). The reactor was pressurized with ethylene to 340 psig, and the contents were heated to 80° C. The supported heterocene or metallocene compound was injected into the reactor to start the polymerization. Ethylene was supplied on demand to keep the reactor pressure at 340 psig. After 30 min., the reactor was vented to recover polyethylene.

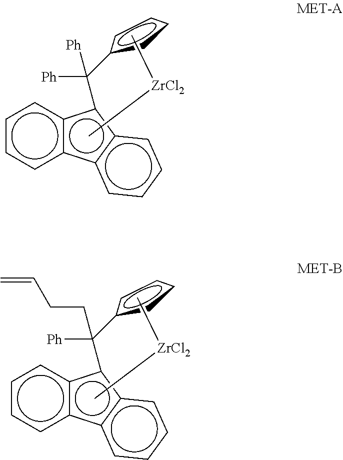

Table I summarizes the metallocene compound and the amount of the metallocene compound, the activity based on the activator-support (A-S) and on the metallocene compound, and the weight average molecular weight (M_{w}), and the density of the polymer produced.

TABLE I
Examples 7-14.

| | | | Support | Metallocene | | |
|---|---|---|---|---|---|---|
| | | Metallocene | Activity | Activity | | Density |
| Example | Metallocene | (mg) | (g/g/h) | (kg/mol/h) | Mw/1000 | (g/mL) |
| 7 | MET-A | 1 | 2755 | 182430 | 250 | 0.9260 |
| 8 | H1 | 1 | 1917 | 133527 | 396 | 0.9202 |
| 9 | H4 | 1 | 5316 | 334458 | 119 | 0.9311 |
| 10 | H3 | 3 | 182 | 11850 | — | 0.9218 |
| 11 | H6 | 3 | 174 | 10424 | — | 0.9240 |
| 12 | MET-B | 1 | 454 | 23392 | 253 | 0.9256 |
| 13 | H2 | 1 | 1773 | 100375 | 222 | 0.9255 |
| 14 | H5 | 1 | 2262 | 110491 | 105 | 0.9281 |

Comparative Examples 7 and 12 provide conventional metallocene compounds and resulting activities and molecular weights relative to the heteroatom containing heterocenes of inventive Examples 8-11 and 13-14. Particularly, each of Examples 8-11 utilized a heterocene comprising a diphenyl bridging group and an unsubstituted or substituted cyclopentadienyl group as Cp, as represented in formulas (I)-(III). The heterocenes used in Examples 8-9 each comprise a 3-(4-pentenyl)) substituted cyclopentadienyl (as does metallocene C1 of Comparative Example 7), whereas the heterocenes used in Examples 10-11 each lack an alkenyl substituent altogether.

Surprisingly, Examples 8-9 each demonstrated either a metallocene activity or a molecular weight that was greatly increased relative to the conventional C1 metallocene of Comparative Example 7. Particularly, heterocene compound H1 (Example 8) produced a molecular weight approximately 60% greater than that of the conventional C1 metallocene (Comparative Example 7). Heterocene compound H4 (Example 9) demonstrated a metallocene activity nearly double that reported for Comparative Example 7. Without being bound by theory, comparisons between the structures of metallocenes in Examples 7-9 suggests that the presence of heteroatoms within the cyclopentadienyl-type group in formulas (I)-(III) above result in significant increase in either catalyst activity or molecular weight. Each of Examples 10-11 lack the butenyl substituent of Comparative Example 7, however, provide further Examples of heterocenes applied to polymerization processes.

Comparative Example 12 and Inventive Examples 13-14 (H2 and H5, respectively) each utilized a metallocene or heterocene that contains a methyl-(4-butenyl) bridging group. Each of Inventive Examples 13-14 demonstrate a drastic increase in activity relative to the metallocene compounds of Comparative Example 12, roughly four and five times the activity, respectively. Further, the polymer product of Inventive Example 13 had a molecular weight and density very similar to that of Comparative Example 12. Similar to Inventive Examples 8-9 relative to Comparative Example 7, each of the metallocenes employed in Examples 13-14 comprise a heteroatom within the aromatic ring structure coordinated to the metal, whereas Comparative Example 12 does not contain a heteroatom within their structure.

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A metallocene compound having the formula:

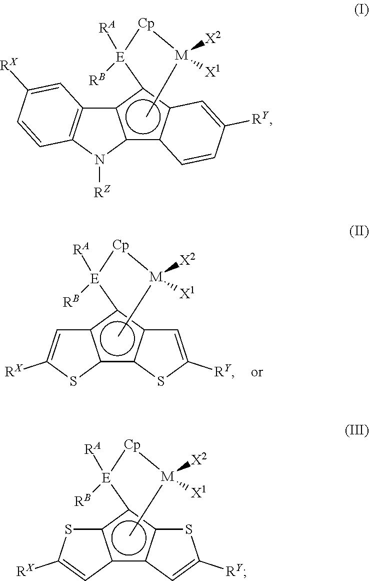

wherein:
M is Ti, Zr, or Hf;
E is C, Si, or Ge;
Cp is a substituted or unsubstituted cyclopentadienyl group;
X¹ and X² independently are a monoanionic ligand;
R^{A} and R^{B} independently are H, a C₁ to C₃₆ hydrocarbyl group, a C₁ to C₃₆ hydrocarboxy group, or a C₁ to C₃₆ hydrocarbylsilyl group; and
R^{X}, R^{Y}, and R^{Z} independently are H or a C₁ to C₃₆ hydrocarbyl group.

Aspect 2. The metallocene compound defined in aspect 1, wherein Cp is a substituted cyclopentadienyl group with an alkyl and/or an alkenyl substituent.

Aspect 3. The compound defined in aspect 1 or 2, wherein Cp is a substituted cyclopentadienyl group with an alkyl substituent, e.g., any C₁ to C₁₈ alkyl group or any C₁ to C₆ linear or branched alkyl group disclosed herein.

Aspect 4. The compound defined in aspect 3, wherein the alkyl substituent is a methyl group, an ethyl group, a propyl group, a butyl group, a pentyl group, a hexyl group, a heptyl group, an octyl group, a nonyl group, or a decyl group.

Aspect 5. The compound defined in aspect 1 or 2, wherein Cp is a cyclopentadienyl group with an alkenyl substituent, e.g., any C₂ to C₁₈ alkenyl group disclosed herein.

Aspect 6. The compound defined in aspect 5, wherein the alkenyl substituent is an ethenyl group, a propenyl group, a butenyl group, a pentenyl group, a hexenyl group, a heptenyl group, an octenyl group, a nonenyl group, or a decenyl group.

Aspect 7. The compound defined in aspect 5, wherein the alkenyl substituent is a C₂ to C₁₂ linear alkenyl group.

Aspect 8. The compound defined in aspect 5, wherein the alkenyl substituent is a C₂ to C₈ terminal alkenyl group or a C₃ to C₆ terminal alkenyl group.

Aspect 9. The compound defined in any one of aspects 1-8, wherein Cp contains only one alkyl or only one alkenyl substituent.

Aspect 10. The compound defined in aspect 1 or 2, wherein Cp is a cyclopentadienyl group with an alkyl and an alkenyl substituent, e.g., any C₁ to C₁₈ alkyl group and any C₂ to C₁₈ alkenyl group disclosed herein.

Aspect 11. The compound defined in any one of aspects 1-10, wherein E is C and R^{A} and R^{B} independently are H or a C₁ to C₁₈ hydrocarbyl group.

Aspect 12. The compound defined in any one of aspects 1-11, wherein R^{A} and R^{B} independently are a methyl group, an ethyl group, a propyl group, a butyl group, a pentyl group, a hexyl group, a propenyl group, a butenyl group, a pentenyl group, a hexenyl group, a phenyl group, or a benzyl group.

Aspect 13. The compound defined in any one of aspects 1-11, wherein R^{A} and R^{B} are phenyl groups.

Aspect 14. The compound defined in any one of aspects 1-11, wherein R^{A} is a C₃ to C₆ terminal alkenyl group and R^{B} is a C₁ to C₆ alkyl group, e.g., a methyl group.

Aspect 15. The compound defined in any one of aspects 1-14, wherein R^{X}, R^{Y}, and R^{Z}, where present, independently are any substituent disclosed herein, e.g., H or a C₁ to C₁₈ hydrocarbyl group, or H or a C₁ to C₆ linear or branched alkyl group.

Aspect 16. The compound defined in any one of aspects 1-14, wherein R^{X}, R^{Y}, and R^{Z}, where present, independently are H, a methyl group, an ethyl group, a propyl group, a butyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group, a benzyl group, or a naphthyl group.

Aspect 17. The compound defined in any one of aspects 1-16, wherein R^{X}, R^{Y}, and R^{Z}, where present, independently are H, a methyl group, an ethyl group, a propyl group, a butyl group, a pentyl group, or a hexyl group.

Aspect 18. The compound defined in any one of aspects 1-17, wherein R^{X}, R^{Y}, and R^{Z}, where present, independently are H, a methyl group, or a tert-butyl group.

Aspect 19. The compound defined in any one of aspects 1-18, wherein R^{Z} is a methyl group.

Aspect 20. The compound defined in any one of aspects 1-19, wherein M is Ti.

Aspect 21. The compound defined in any one of aspects 1-19, wherein M is Zr.

Aspect 22. The compound defined in any one of aspects 1-19, wherein M is Hf.

Aspect 23. The compound defined in any one of aspects 1-22, wherein X¹ and X² independently are any monoanionic ligand disclosed herein.

Aspect 24. The compound defined in any one of aspect 1-23, wherein X¹ and X² independently are H, BH₄, a halide, a C₁ to C₃₆ hydrocarbyl group, a C₁ to C₃₆ hydrocarboxy group, a C₁ to C₃₆ hydrocarbylaminyl group, a C₁ to C₃₆ hydrocarbylsilyl group, a C₁ to C₃₆ hydrocarbylaminylsilyl group, OBR¹², or OSO₂R¹, wherein R¹ is a C₁ to C₃₆ hydrocarbyl group.

Aspect 25. The compound defined in any one of aspects 1-24, wherein X¹ and X² independently are any halide or C₁ to C₁₈ hydrocarbyl group disclosed herein.

Aspect 26. The compound defined in any one of aspects 1-25, wherein X¹ and X² are Cl.

Aspect 27. The compound defined in aspect 1, wherein the compound is selected from the group consisting of:

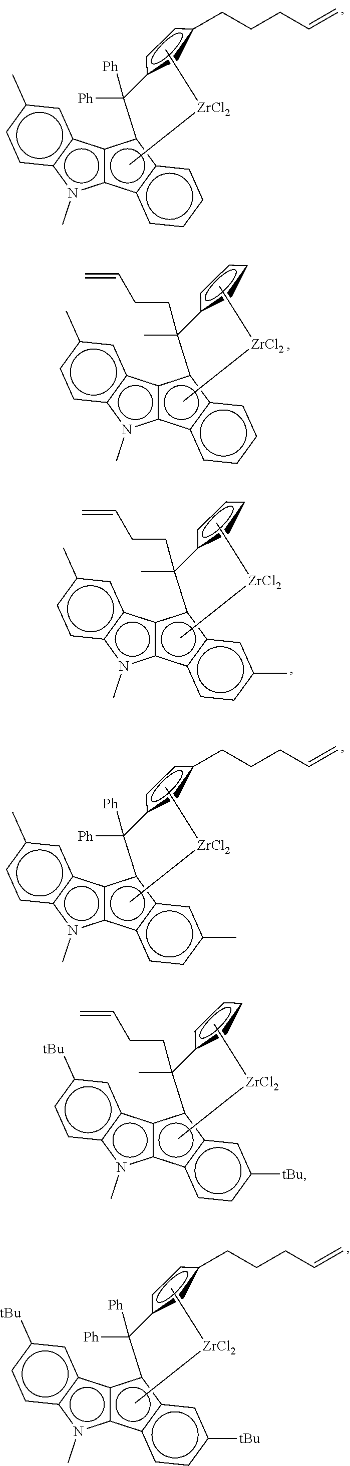

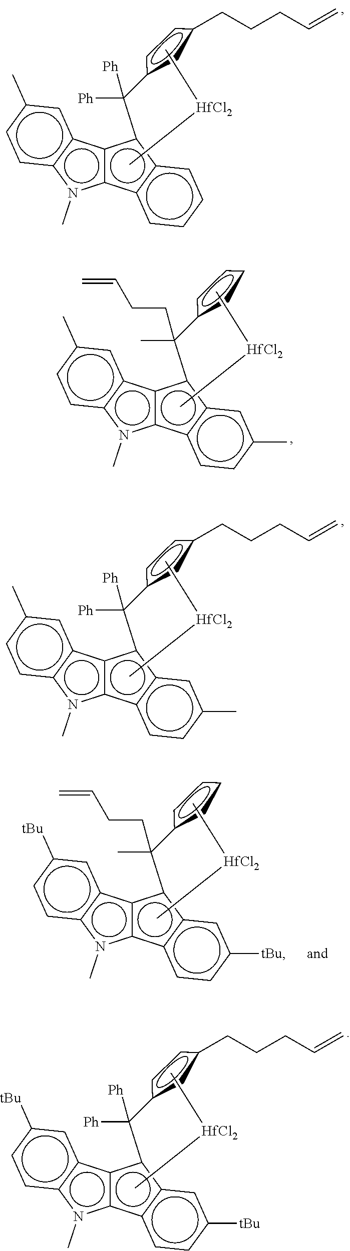

Aspect 28. The compound defined in aspect 1, wherein the compound is selected from the group consisting of

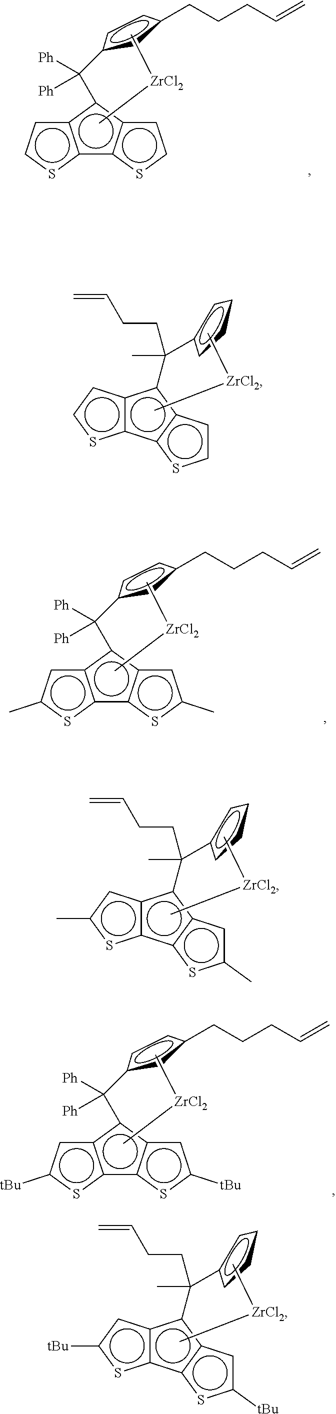

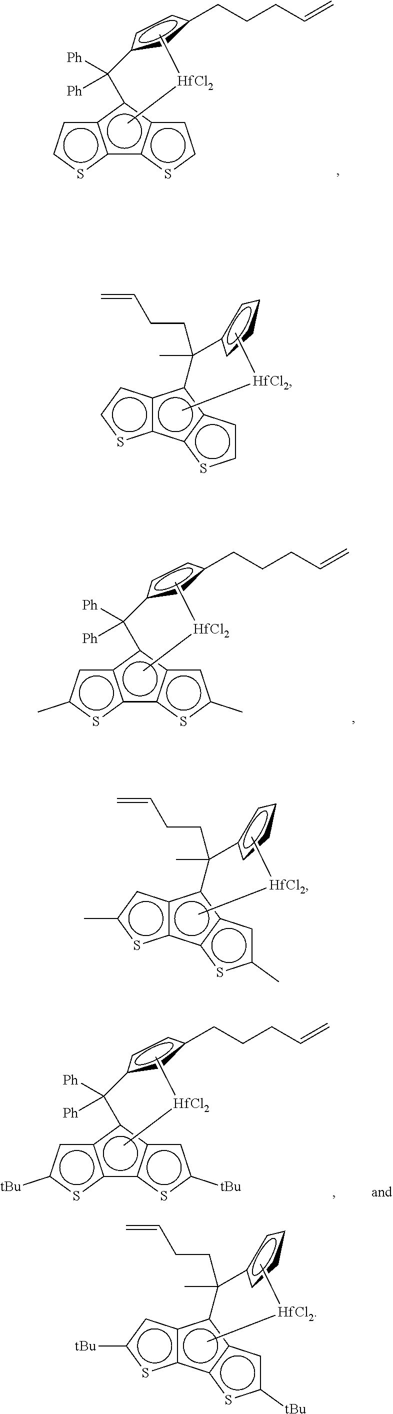

Aspect 29. The compound defined in aspect 1, wherein the compound is selected from the group consisting of:

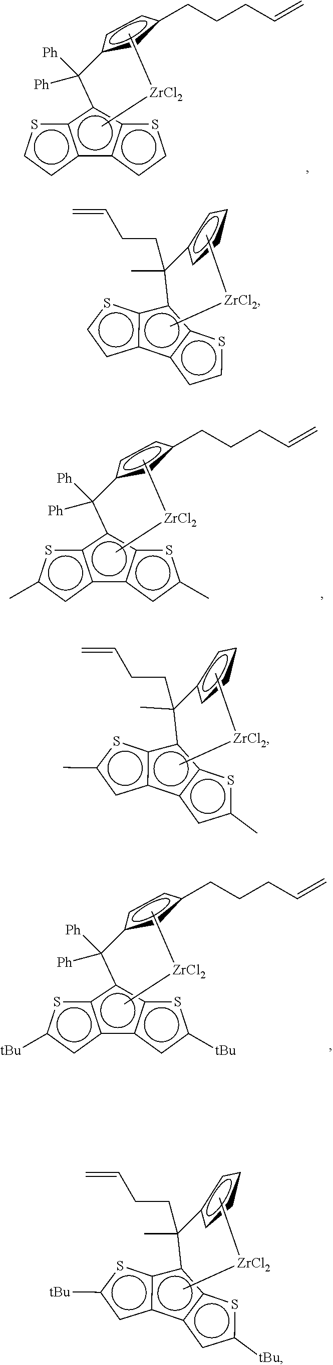

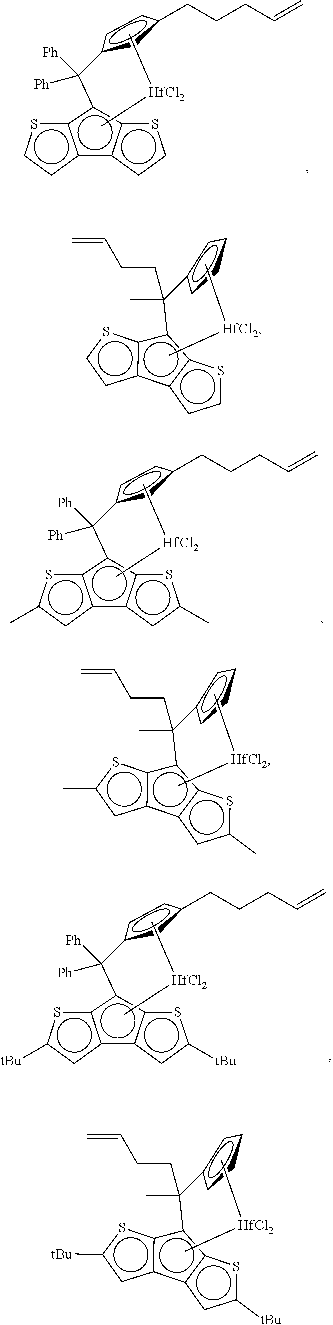

Aspect 30. The compound defined in aspect 1, wherein the compound is selected from the group consisting of:

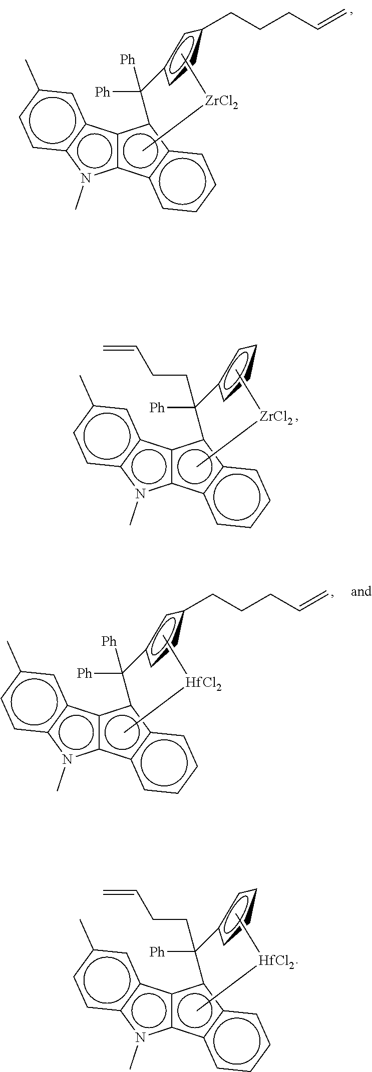

Aspect 31. The compound defined in aspect 1, wherein the compound is selected from the group consisting of:

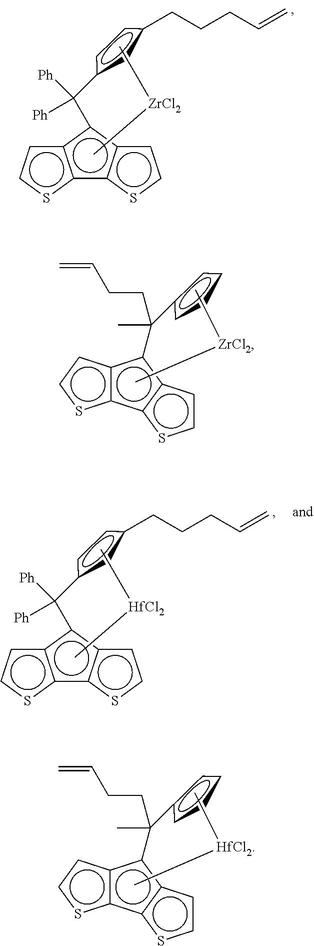

Aspect 32. A catalyst composition comprising the metallocene compound defined in any one of aspects 1-31, an activator, and an optional co-catalyst.

Aspect 33. The composition defined in aspect 32, wherein the activator comprises any suitable chemically-treated solid oxide, e.g., fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof.

Aspect 34. The composition defined in aspect 32 or 33, wherein the activator comprises a fluorided solid oxide and/or a sulfated solid oxide, e.g., fluorided alumina, sulfated alumina, fluorided silica-alumina, sulfated silica-alumina, fluorided silica-coated alumina, fluorided-chlorided silica-coated alumina, sulfated silica-coated alumina, or any combination thereof.

Aspect 35. The composition defined in any one of aspects 32-34, wherein the catalyst composition is substantially free of aluminoxane compounds, organoboron or organoborate compounds, ionizing ionic compounds, or combinations thereof.

Aspect 36. The composition defined in aspect 32, wherein the activator comprises an aluminoxane compound, an organoboron or organoborate compound, an ionizing ionic compound, or any combination thereof.

Aspect 37. The composition defined in any one of aspects 32-36, wherein the catalyst composition comprises a co-catalyst, e.g., any suitable co-catalyst.

Aspect 38. The composition defined in any one of aspects 32-37, wherein the co-catalyst comprises any organoaluminum compound disclosed herein.

Aspect 39. The composition defined in aspect 38, wherein the organoaluminum compound comprises trimethylaluminum (TMA), triethylaluminum (TEA), tri-n-propylaluminum (TNPA), tri-n-butylaluminum (TNBA), triisobutylaluminum (TIBA), tri-n-hexylaluminum, tri-n-octylaluminum (TNOA), or combinations thereof.

Aspect 40. The composition defined in any one of aspects 32-39, wherein the catalyst composition comprises a single metallocene compound having formula (I), (II), or (III), or the catalyst composition comprises two or more metallocene compounds, at least one of which has the formula (I), (II), or (III).

Aspect 41. The composition defined in any one of aspects 32-40, wherein a catalyst activity of the catalyst composition is in any range disclosed herein, e.g., from 150 to 10,000, from 500 to 7,500, or from 1,000 to 5,000 grams, of ethylene polymer per gram of activator per hour, under slurry polymerization conditions, with a triisobutylaluminum co-catalyst, using isobutane as a diluent, and with a polymerization temperature of 80° C. and a reactor pressure of 340 psig.

Aspect 42. The composition defined in any one of aspects 32-41, wherein a metallocene activity of the catalyst composition in an ethylene polymerization process is greater (by any amount disclosed herein, e.g., at least 10%, at least 15%, at least 20%, at least 30%, or at least 35%, up to 50%, 60%, 75%, or 100%) than that of an otherwise identical catalyst system containing an otherwise identical metallocene compound with a fluorenyl group instead of the sulfur-containing or nitrogen-containing aromatic ring system.

Aspect 43. A polymerization process comprising contacting the catalyst composition defined in any one of aspects 32-42 with an olefin monomer and an optional olefin comonomer in a polymerization reactor system under polymerization conditions to produce an olefin polymer.

Aspect 44. The process defined in aspect 43, wherein the olefin monomer comprises any olefin monomer disclosed herein, e.g., any C₂-C₂₀ olefin.

Aspect 45. The process defined in aspect 43 or 44, wherein the olefin monomer and the optional olefin comonomer independently comprise a C₂-C₂₀ alpha-olefin.

Aspect 46. The process defined in any one of aspects 43-45, wherein the olefin monomer comprises ethylene.

Aspect 47. The process defined in any one of aspects 43-46, wherein the catalyst composition is contacted with ethylene and an olefin comonomer comprising a C₃-C₁₀ alpha-olefin.

Aspect 48. The process defined in any one of aspects 43-47, wherein the catalyst composition is contacted with ethylene and an olefin comonomer comprising 1-butene, 1-hexene, 1-octene, or a mixture thereof.

Aspect 49. The process defined in any one of aspects 43-48, wherein the polymerization reactor system comprises a slurry reactor, a gas-phase reactor, a solution reactor, a multizone circulating reactor, or a combination thereof, alternatively, a loop slurry reactor; or alternatively, a fluidized bed reactor.

Aspect 50. The process defined in any one of aspects 43-49, wherein the polymerization reactor system comprises one reactor, two reactors, or two or more reactors.

Aspect 51. The process defined in any one of aspects 43-50, wherein the olefin polymer comprises any olefin polymer disclosed herein.

Aspect 52. The process defined in any one of aspects 43-51, wherein the olefin polymer comprises an ethylene homopolymer, an ethylene/1-butene copolymer, an ethylene/1-hexene copolymer, and/or an ethylene/1-octene copolymer.

Aspect 53. The process defined in any one of aspects 43-52, wherein the olefin polymer comprises an ethylene/1-hexene copolymer.

Aspect 54. The process defined in any one of aspects 43-53, wherein the polymerization conditions comprise a polymerization reaction temperature in a range from 60° C. to 120° C. and a reaction pressure in a range from 200 to 1000 psig (1.4 to 6.9 MPa).

Aspect 55. The process defined in any one of aspects 43-54, wherein the polymerization conditions are substantially constant, e.g., for a particular polymer grade.

Aspect 56. The process defined in any one of aspects 43-55, wherein no hydrogen is added to the polymerization reactor system.

Aspect 57. The process defined in any one of aspects 43-55, wherein hydrogen is added to the polymerization reactor system.

Aspect 58. The process defined in any one of aspects 43-57, wherein the weight-average molecular weight (Mw) of the olefin polymer is in any range disclosed herein, e.g., from 50,000 to 700,000 g/mol, from 75,000 to 500,000 g/mol, from 100,000 to 600,000 g/mol, or from 200,000 to 500,000 g/mol.

Aspect 59. An olefin polymer produced by the process defined in any one of aspects 43-58.

Aspect 60. The polymer defined in aspect 59, wherein the olefin polymer comprises an ethylene homopolymer and/or an ethylene/α-olefin copolymer.

Aspect 61. The polymer defined in aspect 59 or 60, wherein the olefin polymer comprises an ethylene homopolymer, an ethylene/1-butene copolymer, an ethylene/1-hexene copolymer, and/or an ethylene/1-octene copolymer.

Aspect 62. The polymer defined in any one of aspects 59-61, wherein the olefin polymer comprises an ethylene/1-hexene copolymer.

Aspect 63. An article comprising the olefin polymer defined in any one of aspects 59-62.

1. A metallocene compound having the formula: 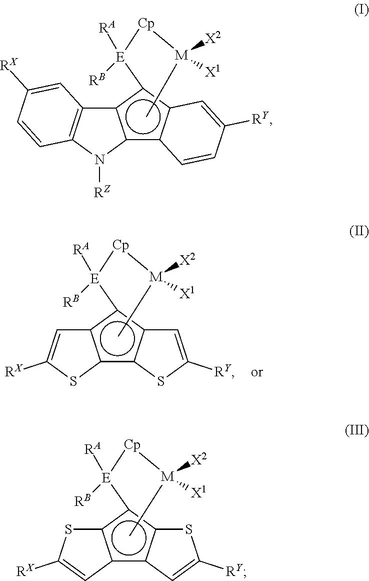
wherein:
M is Ti, Zr, or Hf;
E is C, Si, or Ge;
Cp is a substituted or unsubstituted cyclopentadienyl group;
X¹ and X² independently are a monoanionic ligand;
R^{A} and R^{B} independently are H, C₁ to C₃₆ hydrocarbyl group, a C₁ to C₃₆ hydrocarboxy group, or a C₁ to C₃₆ hydrocarbylsilyl group; and
R^{X}, R^{Y}, and R^{Z} independently are H or a C₁ to C₃₆ hydrocarbyl group.

2. The metallocene compound of claim 1, wherein Cp is a cyclopentadienyl group with a C₂ to C₈ terminal alkenyl group.

3. The metallocene compound of claim 1, wherein R^{A} and R^{B} are phenyl groups.

4. The metallocene compound of claim 1, wherein R^{A} is a C₃ to C₆ terminal alkenyl group and R^{B} is a C₁ to C₆ alkyl group or a phenyl group.

5. The metallocene compound of claim 1, wherein R^{X}, R^{Y}, and R^{Z} are H or a C₁ to C₁₈ hydrocarbyl group.

6. The metallocene compound of claim 1, wherein R^{X}, R^{Y}, and R^{Z} independently are H, a methyl group, an ethyl group, a propyl group, a butyl group, a pentyl group, or a hexyl group.

7. The metallocene compound of claim 6, wherein R is a methyl group.

8. The metallocene compound of claim 1, wherein M is Zr.

9. The metallocene compound of claim 1, wherein X¹ and X² are Cl.

10. The metallocene compound of claim 1 selected from the group consisting of:

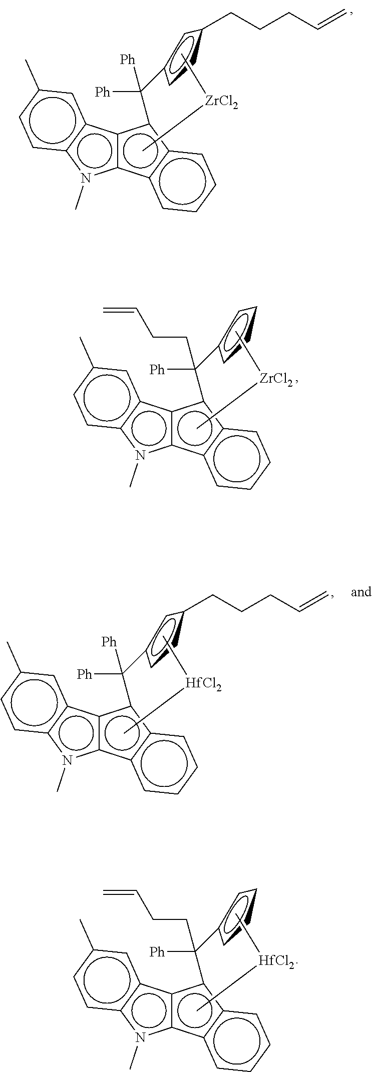

11. The metallocene compound of claim 1 selected from the group consisting of:

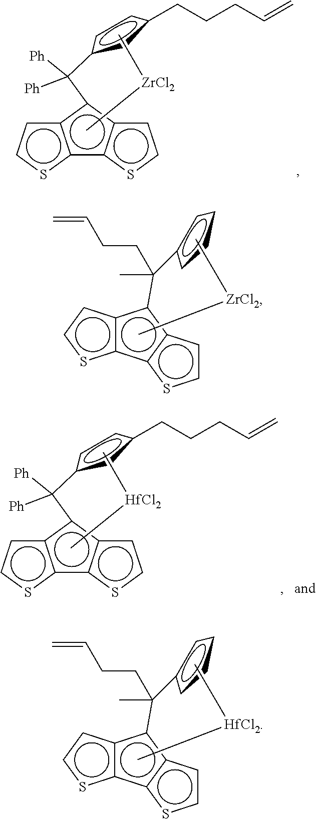

12. A catalyst composition comprising a metallocene compound, an activator, and an optional co-catalyst, wherein the metallocene compound has the formula: 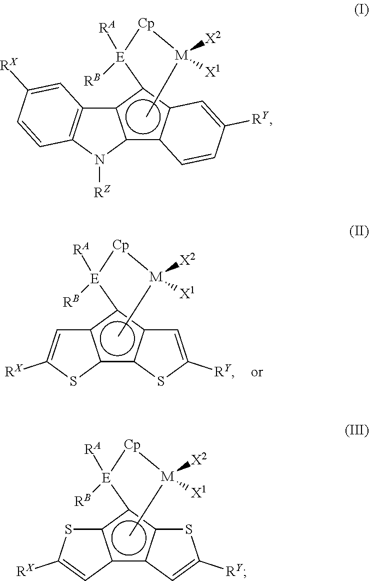
wherein:
M is Ti, Zr, or Hf;
E is C, Si, or Ge;
Cp is a substituted or unsubstituted cyclopentadienyl group;
X¹ and X² independently are a monoanionic ligand;
R^{A} and R^{B} independently are H, a C₁ to C₃₆ hydrocarbyl group, a C₁ to C₃₆ hydrocarboxy group, or a C₁ to C₃₆ hydrocarbylsilyl group; and
R^{X}, R^{Y}, and R^{Z} independently are H or a C₁ to C₃₆ hydrocarbyl group.

13. The catalyst composition of claim 12, wherein the activator comprises an aluminoxane compound, an organoboron or organoborate compound, an ionizing ionic compound, or any combination thereof.

14. The catalyst composition of claim 12, wherein the activator comprises a fluorided solid oxide and/or a sulfated solid oxide.

15. The catalyst composition of claim 14, wherein catalyst composition comprises the co-catalyst, and the co-catalyst comprises an organoaluminum compound comprising trimethylaluminum (TMA), triethylaluminum (TEA), tri-n-propylaluminum (TNPA), tri-n-butylaluminum (TNBA), triisobutylaluminum (TIBA), tri-n-hexylaluminum, tri-n-octylaluminum (TNOA), or combinations thereof.

16. The catalyst composition of claim 12, wherein a metallocene activity of the catalyst composition in an ethylene polymerization process is greater than that of an otherwise identical catalyst system containing an otherwise identical metallocene compound with a fluorenyl group instead of a sulfur-containing or nitrogen-containing aromatic ring system.

17. The catalyst composition of claim 12, wherein a molecular weight of a polymer produced by an ethylene polymerization process is greater than that produced from an otherwise identical catalyst system containing an otherwise identical metallocene compound with a fluorenyl group instead of a sulfur-containing or nitrogen-containing aromatic ring system.

18. A polymerization process comprising contacting the catalyst composition of claim 12 with an olefin monomer and an optional olefin comonomer in a polymerization reactor system under polymerization conditions to produce an olefin polymer.

19. An olefin polymer produced by the process of claim 18.

20. An article comprising the olefin polymer of claim 19.
